(19) United States
(12) Patent Application Publication
(10) Pub. No.: US 2014/0316604 A1
(43) Pub. Date: Oct. 23, 2014

(54) METHOD FOR ACTIVE CONTROL OF FREQUENCY AND VOLTAGE IN A POWER SUPPLY GRID WITH DECENTRALIZED POWER SUPPLY SYSTEMS

(71) Applicants: Egon Ortjohann, Hoexter (DE); Worpong Sinsukthavorn, Soest (DE); Andreas Schmelter, Soest (DE); Nedzad Hamsic, Gelsenkirchen (DE)

(72) Inventors: Egon Ortjohann, Hoexter (DE); Worpong Sinsukthavorn, Soest (DE); Andreas Schmelter, Soest (DE); Nedzad Hamsic, Gelsenkirchen (DE)

(21) Appl. No.: 14/356,925

(22) PCT Filed: Dec. 16, 2011
(86) PCT No.: PCT/EP2011/006392

§ 371 Date: Jun. 10, 2014

(51) Int. Cl. H02M 1/42

(52) U.S. Cl. CPC H02M 1/42
USPC 700/298

(57) ABSTRACT

The invention relates to a method for actively controlling in a feedback control at least one output parameter (fᵢ, Vᵢ, Pᵢ, Qᵢ) of a decentralized power generating unit (1) feeding power into a power supply grid (14) having a plurality of such decentralized power generating units, the power generating unit (1) being coupled to the grid (14) at a grid tied point (16). The actual resistance (Rᵢ), reactance (Xᵢ) and magnitude (|Zᵢ|) of the impedance (Zᵢ) of the power generating unit (1) at the tied point (16) is determined and a first quotient (Rᵢ/|Zᵢ|) between the resistance (Rᵢ) and impedance magnitude (|Zᵢ|) and a second quotient (Xᵢ/|Zᵢ|) between the reactance (Xᵢ) and the impedance magnitude (|Zᵢ|) is calculated. These quotients (Rᵢ/|Zᵢ|, Xᵢ/|Zᵢ|) are used for the feedback control of the at least one output parameter (fᵢ, Vᵢ, Pᵢ, Qᵢ).

The present invention is in the technical field of electrical power systems. More particularly, the present invention is in the technical field of load sharing control. It relates to a method for actively controlling in a feedback control at least one output parameter of a decentralized power generating unit feeding power into a power supply grid having a plurality of such decentralized power generating units, the power generating unit being coupled to the grid at a grid tied point.

Distributed Generation (DG) technologies are becoming potential contributors of electricity supplied to electric utilities. Integrating a large number of such Energy Conversion Systems (ECSs) based on Distributed Energy Resources (DERs) and partly on Renewable Energy Sources (RESs) into main grids, automatically leads to generation fluctuation, altered grid infrastructure, change in dynamic behaviors, etc. Since the main grid structure cannot be changed rapidly, the existing control structure based on conventional power systems should be used as a guideline to develop a new grid control for decentralized power supply systems.

However, as the conventional primary control strategy of Power plants in the high voltage transmission networks is based on the inductive nature of power systems, the main issues of medium voltage and low voltage networks, concerning the resistive nature of power systems, are not taken into consideration. Therefore, conventional droop controls that are used in conventional power systems to get a load sharing related to the grid frequency and the voltage will no longer be efficient when applied in medium and low voltage networks.

The present invention is a flexible, adaptable and general droop control for power sharing, which can be implemented into the control of generating units (synchronous machine, inverters, etc.) and can be applied in all voltage levels of power supply systems.

### BRIEF DESCRIPTION OF THE DRAWINGS

FIG. 1: a schematic view of feeding modes related to the grid side of the present invention;

FIG. 2: a schematic view of an inverter in ECS driven feeding mode as flexible primary interface between ECS and grid of the present invention;

FIG. 3: a schematic view of a general control of a system operating in a grid-driven feeding mode inverter (grid forming, grid supporting) of the present invention;

FIG. 4: a schematic view of a general control of a system operating in an ECS-driven feeding mode inverter (grid parallel) of the present invention;

FIG. 5: a schematic view of the general view of inverter connected to the grid (gate impedance) of the present invention;

FIG. 6: a schematic view of innovative control of a system operating in a grid-driven feeding mode inverter (forming, supporting) based on AGIDC and grid impedance measurement method of the present invention;

FIG. 7: a schematic view of innovative control of a system operating in an ECS-driven feeding mode inverter (parallel) based on AGIDC and grid impedance measurement method of the present invention;

FIG. 8: a schematic view of active and reactive power at bus-i in power flow study of the present invention;

FIG. 9: a schematic view of conventional droop functions (a) frequency/active power and (b) voltage/reactive power of the present invention;

FIG. 10: a schematic view of rotational in coordinate systems of the present invention;

FIG. 11: a schematic view of rotational in coordinate systems with pointed out trigonometry explanation for P′ variable of the present invention;

FIG. 12: a schematic view of rotational in coordinate systems with pointed out trigonometry explanation for Q′ variable of the present invention;

FIG. 13: a schematic view of movement of impedance Z related to the rotating angle φ of the present invention;

FIG. 14: a schematic view of new droop control diagram for grid forming mode of the present invention;

FIG. 15: a schematic view of a general control of a system operating in a grid-driven feeding mode inverter i (grid forming) with new droop control of the present invention;

FIG. 16: a schematic view of a general control of a system operating in a grid-driven feeding mode synchronous generator i (grid forming) with new droop control of the present invention;

FIG. 17: a schematic view of conventional droop functions (a) active power/frequency and (b) reactive power/voltage of the present invention;

FIG. 18: a schematic view of rotational in coordinate systems of the present invention;

FIG. 19: a schematic view of rotational in coordinate systems with pointed out trigonometry explanation for δ′ variable of the present invention;

FIG. 20: a schematic view of rotational in coordinate systems with pointed out trigonometry explanation for V′ variable of the present invention;

FIG. 21: a schematic view of new droop control diagram for grid supporting mode of the present invention;

FIG. 22: a schematic view of a general control of a system operating in a grid-driven feeding mode inverter i (grid supporting) with new droop control of the present invention;

FIG. 23: a schematic view of a general control of a system operating in a grid-driven feeding mode synchronous generator i (grid supporting) with new droop control of the present invention;

FIG. 24: a schematic view of a general control of a system operating in an ECS-driven feeding mode inverter i (grid parallel) with new droop control of the present invention;

FIG. 25: a schematic view of new droop control diagram for grid forming mode with additional selective functions of the present invention;

FIG. 26: a schematic view of new droop control diagram for grid supporting and grid parallel mode with additional selective functions of the present invention;

### DETAILED DESCRIPTION OF THE INVENTION

The fundamental architecture of centralized power supply systems is characterized by unidirectional power flow from centralized power plants, located at extra high voltage (EHV) and high voltage (HV) levels of the transmission networks, down to distributed consumers located at medium voltage (MV) and low voltage (LV) levels of the distribution networks. The control and stabilization of state variables (frequency and voltage) is done by large power plants, which means that the grid can only actively control and respond to disturbances by continuously balancing the output of power plants located at EHV and HV levels. In contrast, MV and LV levels are in the traditional layout passively controlled. Customer demand is more or less not controllable, and the grid can only react passively to the changes in demand through centralized control. The operation of centralized power systems is limited by basic network components (i.e. lines, transformers, switches, switchable capacitors). This means that the dispatching of power and network control is typically the responsibility by the power plants and the centralized control units respectively the dispatch centers.

As the old centralized power supply systems are changing, the trend of future power supply systems will move toward decentralized power supply systems in combination with renewable energy resources (RESs). The power system penetration of distributed generation (DG) and distributed energy resources (DERs) in combination with RESs is expected to play a key role in future power systems and furthermore in Smart Grids. Especially DERs, which are mainly used for medium and small energy conversion systems (ECSs) in MV and LV networks, will be a main focus in decentralized power supply systems. These decentralized systems can be recognized by their bidirectional power flow, which means that the power flow can range from lower to higher voltage levels.

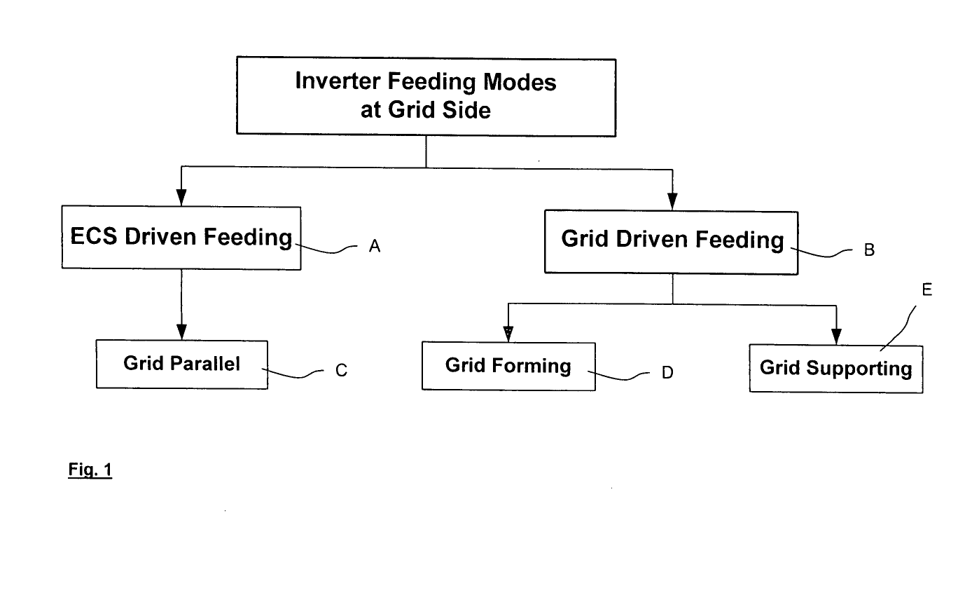

According to the future requirements of power supply systems, DERs based DG should be actively integrated into the active grid control to maintain the state variables frequency and voltage of the grid. To get a general strategy for the dynamic control of DGs, the requirements of the physical behavior in power supply systems have to be taken into consideration for the established control functionality of conventional grids. This means control functionality for the DGs is needed to bring together the decentralized and centralized generators in compatible coexistence. In order to fulfill these requirements of future decentralized power supply systems, the power electronics devices, like inverters, can be used as intelligent and multi-functional primary interfaces between ECS and grids. The general categorization of inverter topologies concerning their operation mode is shown in FIG. 1.

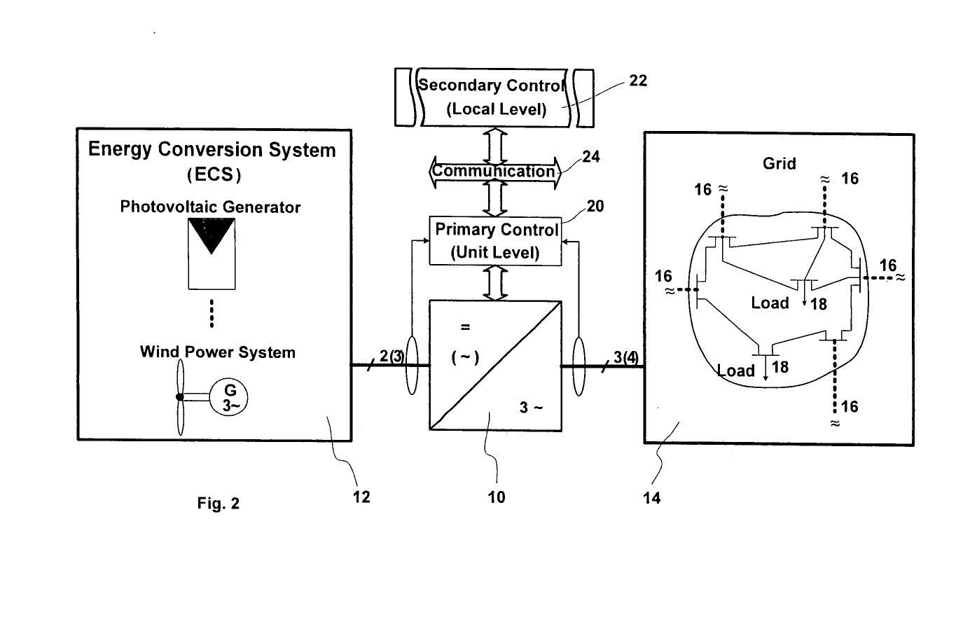

Feeding modes of the inverter can be separated into two types as depicted in FIG. 1 which are inverter of ECS driven feeding mode A and inverter of grid driven feeding mode B, see the disclosure in publication “Advanced Control Strategy for Three-Phase Grid Inverters with Unbalanced Loads for PV/Hybrid Power Systems” by E. Ortjohann, A. Mohd, N. Hamsic, D. Morton, O. Omari, presented at 21^{th} European PV Solar Energy Conference, Dresden, 2006. An inverter of ECS driven feeding mode A may be realized through a grid parallel inverter C. In this context, the ECS has to be interpreted in an expanded way. This means all opportunities in the use of an inverter as a grid tied interface. As shown in FIG. 2, the inverter 10 provides decoupling between the voltages across the terminals of the ECS 12 from one side and the grid voltage of grid 14 from the other side. It also provides a decoupling between the frequency of the ECS 12 from one side and the grid frequency from the other side.

In FIG. 2 it is depicted exemplary that the ECS 12 may be a photovoltaic generator providing a DC voltage to the inverter 10 via two lines. In an alternative, it may be a wind power system with a three phase synchronous generator G providing three phase AC voltage via three lines to the inverter 10. The inverter 10 provides three phase AC voltage to the grid 14 via a connection of three lines to the grid or four lines considering earth as well. The grid 14 is schematically depicted in FIG. 2 having five decentral power feeding tied points 16 and two points 18 to which a power consuming load is connected. The inverter 10 is controlled by a primary control 20 being implemented into the inverter 10 itself on the basis of the electrical parameters on the input and output side of the inverter 10, and by a secondary control 22 on a local level. Primary control 20 and secondary control 22 are interconnected via a communication link 24.

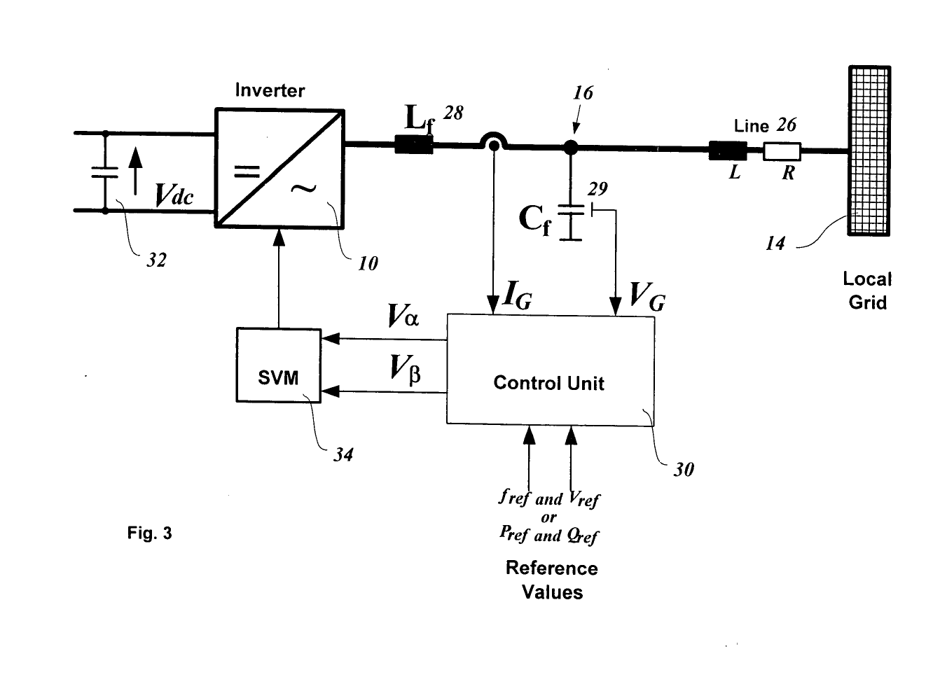

An inverter in grid-driven feeding mode B can be realized through two different cases, which are grid forming D and grid supporting modes E. An inverter in a grid-forming mode D is responsible for establishing the voltage and the grid frequency as state variables and maintaining them, see publication “Conceptual Development of a General Supply Philosophy for Isolated Electrical Power Systems” by O. Omari, vol. PhD. Soest, Germany: South Westphalia University of Applied Sciences, 2005. This is done by increasing or decreasing its power production in order to keep the power balance in the electrical system. An inverter in a grid-supporting mode E feeds predefined amounts of power which are normally specified by a management unit, for example, a load dispatch center. Therefore, the power production in such a case is not a function of the power imbalances in the grid. Nevertheless, the predefined amounts of power for these units may be adjusted. The management system may change the reference values according to the system's requirements and the units' own qualifications, see A. Mohd: “Development of Modular Grid Architecture for Decentralized Generators in Electrical Power Supply System with Flexible Power Electronics”, Dissertation, Joint-PhD Program between The University of Bolton, Bolton, UK, in cooperation with South Westphalia University of Applied Sciences—Soest, Soest, Germany, January 2010. The general control strategy of a grid-driven feeding mode inverter B can be described in FIG. 3. In addition, this kind of definition is general, which can also be expandable to synchronous generators for the control side.

FIG. 3 shows an inverter 10 in a grid driven feeding mode feeding power from a DC link 32 into a grid 14 to which the inverter 10 is connected via line 26 generally represented as RL-combination. The control is based on the voltage V_{G} and the current I_{G} measured at the tied point 16 which are provided to a control unit 30. Reference values are provided to the control unit 30 as well, in case of grid forming mode the grid voltage V_{ref} and the grid frequency f_{ref} and in case of grid supporting mode the active power P_{ref} and the reactive power Q_{ref}. The control unit 30 calculates a set voltage in α and β coordinates as input variables for a state variable model controlling the power electronic switches of the inverter 10 in order to obtain the specified set voltage at the output terminals of the inverter 10. From the grid's point of view the generating unit 10, 32 is represented at the tied point 16 having a capacitance 29 to earth and inductivity 28. Schematically, the voltage V_{G} is measured at this capacitance 29 and the current I_{G} is measured at this inductivity 28.

An electrical system must include grid-driven feeding units (inverters, synchronous generators) to maintain its power balance and the power sharing of the units. If an electrical system has one grid-driven feeding unit only, then it should be the grid-forming unit as described in O. Omari “Conceptual Development of a General Supply Philosophy for Isolated Electrical Power Systems”. If there is more than one grid-driven feeding point in an electrical system, one of them, at least, takes the responsibility of forming the grid state-variables frequency and voltage (D) and the others function as grid-supporting units (E).

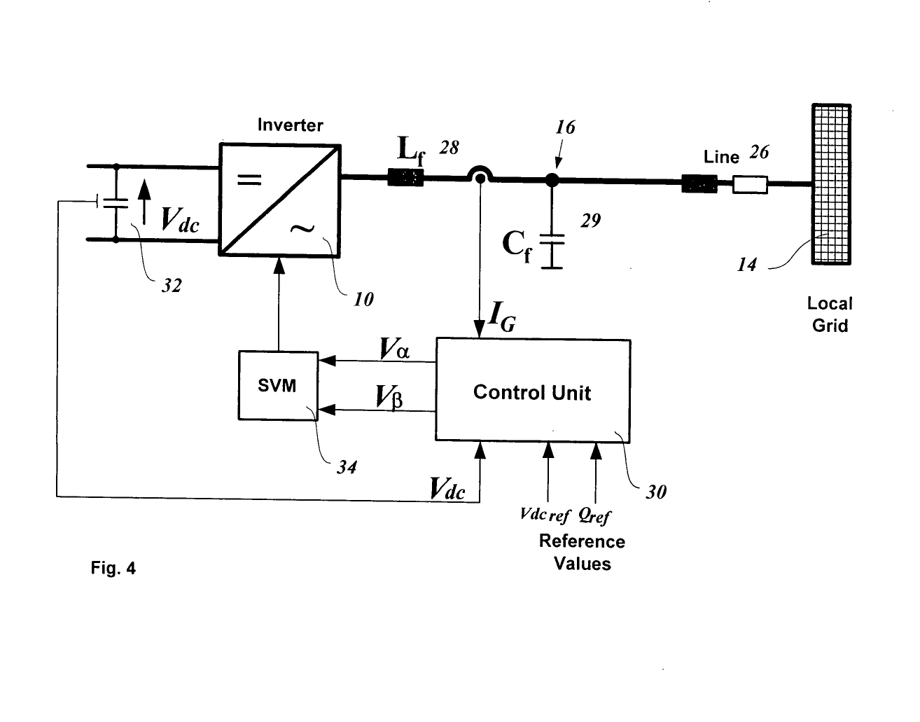

An inverter in ECS-driven feeding mode A is a grid parallel mode C which is a power production unit. It is not controlled according to the requirements of the electrical system. RESs such as wind energy converters and photovoltaic systems (see FIG. 2) may be used as ECSs 12 to feed their maximum power into the grid 14 (standard applications in conventional grids). The general control strategy of ECS-driven feeding mode inverters 10 can be described in FIG. 4. In addition, this kind of definition is general, which can also be expandable to synchronous generators for the control side.

FIG. 4 shows the same basic electric structure as FIG. 3 but for an inverter 10 in grid parallel mode. The control of the inverter 10 differs from the control in FIG. 3 in that instead of the output inverter voltage V_{G} the DC-link 32 voltage V_{dc}, the reference value Vdc_{ref} for the DC-link 32 and the reactive power reference value Q_{ref} is provided to the control unit 30 and used to calculate the α and β coordinates of the set voltage.

Since the control topologies and infrastructure of existing power systems cannot be rapidly changed, the design and development of new systems related to maintenance, operation, security, protection and efficiency must follow the Union for the Coordination of the Transmission of Electricity (UCTE) handbook, Grid Code regulations (UCTE: “Operation Handbook—Introduction”, Final v2.5 E, 24 Jun. 2004, July 2004; and UCTE: “Operational Handbook—Policy 1: Load-Frequency Control”, Final Version (approved by SC on 19 Mar. 2009), March 2009), which are applied in transmission systems. New control strategies and concepts for the grid integration should be based on conventional power systems. Moreover, to get load sharing to the power generators related to the active and reactive power in combination to the state variables, the droop control functions, introduced in the German Patent Application DE 101 40 783 A 1, are used in conventional power supply systems. This load sharing strategy is mainly implemented in the EHV and HV levels in the grid. This load sharing strategy is mainly orientated to transmission network behavior and it is based on the inductive nature of power systems.

Therefore, conventional droop functions in DE 101 40 783 A 1 that are used in conventional power systems cannot be used efficiently when applied in MV and LV networks. The physical behavior of MV and LV networks, concerning the resistive nature of this kind of grids, are not taken into consideration in this droop functions. The theoretical background of control scheme based on the frequency and voltage droop which takes the resistive (R) and reactive (X) line impedance ratio into account is introduced in the publication “A Voltage and Frequency Droop Control Method for Parallel Inverters” by K. De Brabandere, B. Bolsens, J. Van den Keybus, A. Woyte, J. Driesen, R. Belmans, IEEE Transactions on Power Electronic, Vol. 22 (4), pp-1107-1115, 2007. However, to achieve an efficient adaptive droop control, taking the resistive and reactive line impedance ratio into account is not sufficient.

It is therefore an object of the present invention to provide a new method for actively controlling the voltage and the frequency of a grid feeding power generating unit in order to get a balanced load sharing amongst all the power generators feeding the grid, the method being able to be efficiently applied in EHV and HV as well as in MV and LV networks.

This object is achieved by the method according to claim 1. Advantageous further developments are given in the subclaims and described hereinafter.

According to the invention it is proposed a method for actively controlling in a feedback control at least one output parameter (fᵢ, Vᵢ, Pᵢ, Qᵢ) of a decentralized power generating unit feeding power into a power supply grid having a plurality of such decentralized power generating units, the power generating unit being coupled to the grid at a grid tied point, wherein the actual resistance (Rᵢ), reactance (Xᵢ) and magnitude (|Zᵢ|) of the impedance (Zᵢ) of the power generating unit (1) at the tied point is determined and a first quotient (Rᵢ/|Zᵢ|) between the resistance (Rᵢ) and impedance magnitude (|Zᵢ|) and a second quotient (Xᵢ/|Zᵢ|) between the reactance (Xᵢ) and the impedance magnitude (|Zᵢ|) is calculated and used for the feedback control of the at least one output parameter (fᵢ, Vᵢ, Pᵢ, Qᵢ).

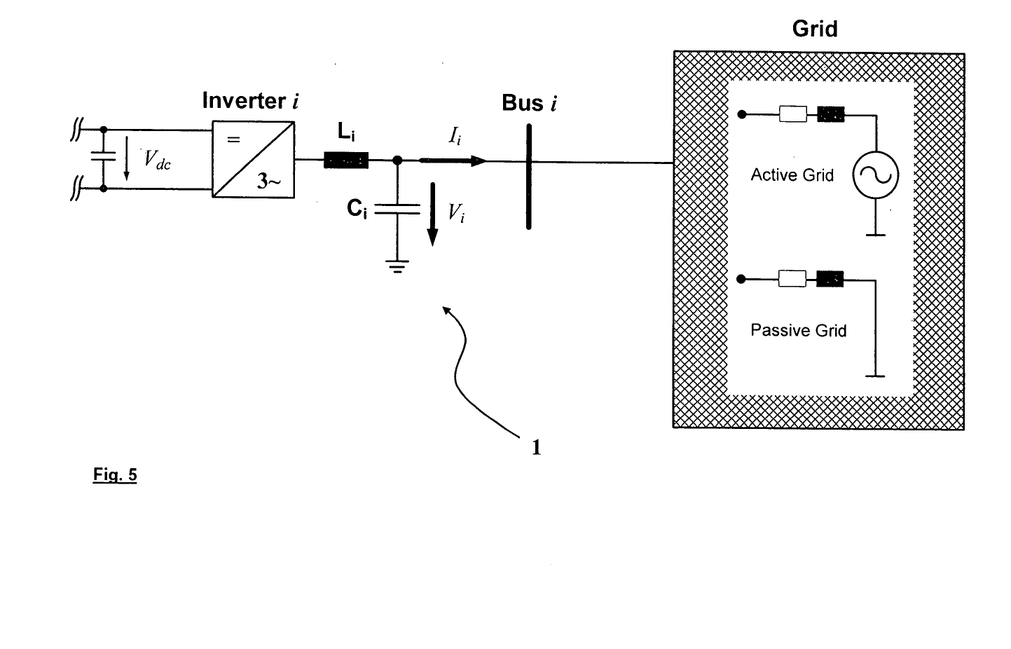

The basic idea of the method according to the invention is to take into account the individual impedance of the grid tied point of each power generating unit 1, as shown in FIG. 5 which is the main important key aspect of the present method according to the invention leading to a general Adaptive Grid Impedance Droop Control, abbreviated as AGIDC in the following. Moreover, the proposed developed general AGIDC in combination with a gate impedance measurement method can handle any change of any disturbance in any voltage level of power system.

A gate impedance measurement method that could be used is, for example, known from Bernd Voges: “Schutzmaβnahmen gegen Selbstlauf dezentraler Wandlersysteme in elektrischen Energieversorgungsnetzen”, Dissertation Universität Paderborn, D14-123, 1997, page 43 and following, or from Detlef Schulz: “Netzrückwirkungen—Theorie, Simulation, Messung und Bewertung”, VDE-Verlag, 1. Issue 2004, ISBN-Nr.: 3-8007-2757-9, page 65 and following.

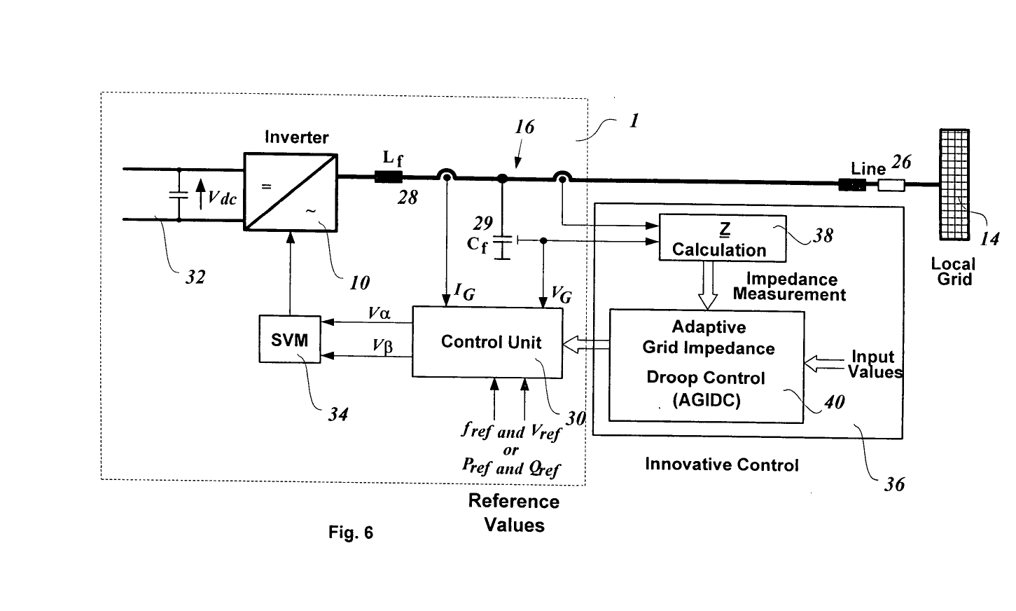

FIG. 6 shows the innovative control method of a power generating unit 1 according to the invention operating with a grid-driven feeding mode inverter 10 (grid forming D or grid supporting E) based on AGIDC and grid impedance measurement. The schematic disclosure of FIG. 6 is based on FIG. 3 expanded by an innovative control unit 36 in which the proposed innovative control method is implemented. This control unit 36 comprises an impedance determination unit 38 to determine the resistive impedance Rᵢ and the reactive impedance Xᵢof the power generating unit 1 at the grid tied point 16 and an adaptive grid impedance droop control (AGIDC) unit 40. The adaptive grid impedance droop control (AGIDC) for the inverter 10 in grid-driven feeding mode B (grid forming D or grid supporting E) is explained in the following.

The impedance determination unit 38 can determine the resistive impedance Rᵢ and the reactive impedance Xᵢ of the power generating unit 1 as described in the following:

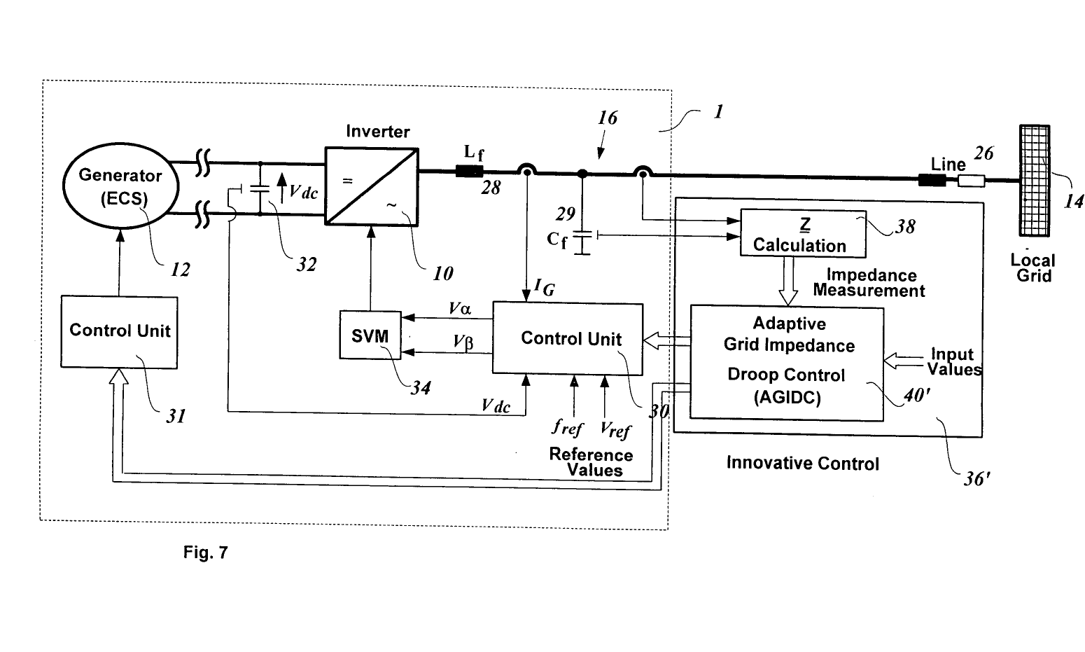

With reference to impedance determination unit 38 in FIG. 6 and FIG. 7, a high resolution of current I_{G} and voltage V_{G} is necessary for the impedance calculation algorithm of function block 38, i.e. impedance determination unit. The complex impedance Z is given by

$$\underline{Z} = R + j X = \frac{\underline{V}}{\underline{I}} = \frac{V {e}^{j δ}}{I {e}^{j γ}} = \frac{V}{I} {e}^{j ( δ - γ )}$$

where R is a real part and X is an imaginary part. In the case under consideration the complex voltage V and the complex current I are assumed to be stationary sinusoidal functions. However, the relation between the impedance and the frequency has to be taken into account. The description based on measurement classification is clarified in Voges, page 44 (see literature reference given above).

To determine the complex impedance, it is obviously that the absolute value of voltage and current are necessary. However, the phase shift between voltage and current is also required in order to calculate the impedance angle (α=δ−γ). The determination methods are divided into two groups (see also Voges):
Measurement of above nominal frequency
Measurement of steady state frequency.

Problems of the impedance determination method and further information are discussed in Voges.

In facts, the determination of complex impedance is done through the injection of current or power at the grid connection point (FIG. 6 and FIG. 7). Accordingly, the values of current I_{G} and voltage V_{G} at connection point are measured (in single-phase as well as in multi-phase systems) and applied to function block 38 (FIG. 6 and FIG. 7) in order to calculate the complex impedance Z. Moreover, the time resolution and the accuracy of the measurement of the voltage and current is an important factor of the algorithm in function block 38 to get the values of the impedance Z with sufficient accuracy for the AGIDC.

Afterwards, the calculated complex grid impedance is applied to AGIDC function block 40 (FIG. 6 and FIG. 7). Regarding the calculation process, the complex grid impedance can be determined and transferred cyclically (at fixed time points) as well as event-driven. Through this, the controller parameter can be adaptively controlled based on the AGIDC function block 40.

FIG. 7 shows the innovative control method of a power generating unit 1 according to the invention operating an ECS-driven feeding mode inverter 10 (grid parallel C) based on AGIDC and grid impedance measurement. The schematic disclosure of FIG. 7 is based on FIG. 4 expanded by an innovative control 36′ in which the proposed innovative control method is implemented. This control 36′ comprises an impedance determination unit 38 as previously described with reference to FIG. 6 to determine the resistive impedance Rᵢ and the reactive impedance Xᵢ of the power generating unit 1 at the grid tied point 16 and an adaptive grid impedance droop control (AGIDC) unit 40′. Furthermore, FIG. 7 depicts another control unit 31 that receives output parameters of the adaptive grid impedance droop control (AGIDC) unit 40′ for controlling the ECS 12, in particular a synchronous generator, feeding DC-link 32. The adaptive grid impedance droop control (AGIDC) for the inverter 10 in grid-parallel mode C is explained in the following.

According to the invention the controlled output parameter can be the frequency fᵢ of the power generating unit, wherein the method can comprise the steps of:
determining the actual active power Pᵢ and reactive power Qᵢ of the power generating unit that are fed into the grid at the grid tied point,
calculating the active power difference ΔPᵢ between the actual active power Pᵢ delivered from the power generating unit 1 and a given reference active power P_{ref,i},
calculating the reactive power difference ΔQᵢ between the actual active power Qᵢ delivered from the power generating unit 1 and a given reference active power Q_{ref,i},
using the second quotient Xᵢ/|Zᵢ| to calculate a first frequency product Δf_{i,P} of the active power difference ΔPᵢ, the second quotient Xᵢ/|Zᵢ| and a given frequency droop factor K_{f,i},
using the first quotient Rᵢ/|Zᵢ| to calculate a second frequency product Δf_{i,Q} of the reactive power difference ΔQᵢ, the first quotient Rᵢ/|Zᵢ| and the frequency droop factor K_{f,i}, and
calculating the sum of the first Δf_{i,P} and the negative second frequency product Δf_{i,Q} to get a frequency correction term Δf_{i,P}−Δf_{i,Q} which is added to the error f_{ref}−fᵢ of the feedback control of the frequency fᵢ.

These method steps can be used for the frequency droop control of a power generating unit with an inverter or synchronous generator in grid forming mode D.

Additionally or alternatively, the controlled output parameter or another controlled output parameter can be the voltage Vᵢ of the power generating unit. In this case the method uses the precalculated active power difference ΔPᵢ and reactive power difference ΔQᵢ and further comprises the steps of:
using the first quotient Rᵢ/|Zᵢ| to calculate a first voltage product ΔV_{i,P} of the active power difference ΔPᵢ, the first quotient Rᵢ/|Zᵢ| and a given voltage droop factor K_{V,i},
using the second quotient Xᵢ/|Zᵢ| to calculate a second voltage product ΔV_{i,Q} of the reactive power difference ΔQᵢ, the second quotient Xᵢ/|Zᵢ| and the voltage droop factor K_{V,i}, and
calculating the sum of the first ΔV_{i,P} and the second voltage product ΔV_{i,Q} to get a voltage correction term ΔV_{i,P}+ΔV_{i,Q} which is added to the error V_{ref,i}−Vᵢ of the feedback control of the voltage Vᵢ.

These method steps can be used for the voltage droop control of a power generating unit with an inverter or synchronous generator in grid forming mode D. Together the frequency droop control and voltage droop control form the adaptive grid impedance droop control (AGIDC) for an inverter or synchronous generator in grid forming mode D.

In another embodiment of the invention the controlled output parameter can be the active power Pᵢ of the power generating unit. In this case the method can comprise the steps of:
determining the actual frequency fᵢ and voltage Vᵢ of the power generating unit at the grid tied point,
calculating the frequency difference Δfᵢ between the actual frequency fᵢ of the power generating unit 1 and a given reference frequency f_{ref},
calculating the voltage difference ΔVᵢ between the actual voltage Vᵢ of the power generating unit and a given reference voltage V_{ref,i},
using the second quotient Xᵢ/|Zᵢ| to calculate a first active power product ΔP_{i,f} of the frequency difference Δfᵢ, the second quotient Xᵢ/|Zᵢ| and a given active power droop factor 1/K_{f,i},
using the first quotient Rᵢ/|Zᵢ| to calculate a second active power product ΔP_{i,V} of the voltage difference ΔVᵢ, the first quotient Rᵢ/|Zᵢ| and the active power droop factor 1/K_{f,i}, and
calculating the sum of the first ΔP_{i,f} and the negative second active power product ΔP_{i,V} to get an active power correction term ΔP_{i,f}+ΔP_{i,V} which is added to the error P_{ref,i}−Pᵢ of the feedback control of the active power Pᵢ.

These method steps can be used for the active power droop control of a power generating unit with an inverter or synchronous generator in grid supporting mode E or with an ECS-driven inverter in grid parallel mode C.

Additionally or alternatively, the controlled output parameter can be the reactive power Qᵢ of the power generating unit. In this case the method uses the precalculated frequency difference Δfᵢ and voltage difference ΔVᵢ and further comprises the steps of:
using the first quotient Rᵢ/|Zᵢ| to calculate a first reactive power product ΔQ_{i,f} of the frequency difference Δfᵢ, the first quotient Rᵢ/|Zᵢ| and a given reactive power droop factor 1/K_{V,i},
using the second quotient Xᵢ/|Zᵢ| to calculate a second reactive power product ΔQ_{i,V} of the voltage difference ΔVᵢ, the second quotient Xᵢ/|Zᵢ| and the reactive power droop factor 1/K_{V,i}, and
calculating the sum of the first ΔQ_{i,f} and the second reactive power product ΔQ_{i,V} to get a reactive power correction term ΔQ_{i,f}+ΔQ_{i,V} which is added to the error Q_{ref,i}−Qᵢ of the feedback control of the reactive power Qᵢ.

These steps can be used for the reactive power droop control of a power generating unit with an inverter or synchronous generator in grid supporting mode E or with an ECS-driven inverter in grid parallel mode C. Together the active power droop control and reactive power droop control form the adaptive grid impedance droop control (AGIDC) for an inverter or synchronous generator in grid supporting mode E or for an ECS-driven inverter in grid parallel mode C.

To be clearly described, the physical behavior of load flow will be the starting point to analyze the problem. This physical behavior concerning the control tasks in electrical power systems can be pointed out in the mathematical way by decoupled load flow description, as done in “Power System Analysis” by J. Grainger and W. Stevenson, “McGraw-Hill Series in Electrical and Computer Engineering”, ISBN 0-07-061293-5.

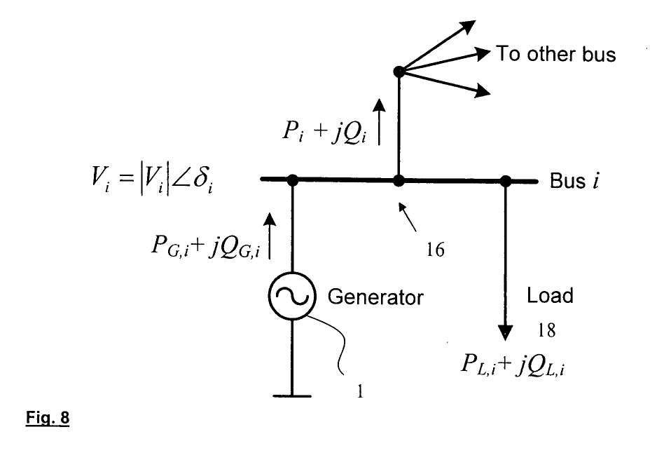

For a general power network, complex power at sending bus-i, i.e. the grid tied point at which a power generating unit is connected to the grid, can be also described as FIG. 8. The equations for the active power Pᵢ and reactive power Qᵢ represent the power flow delivered into the network at bus-i, i.e. at the grid tied point, which can be expressed as polar form equations:

$$\begin{matrix}{P}_{i} = {P}_{G , i} - {P}_{L , i} = {\sum }_{j = 1}^{n} {V}_{i} \cdot {V}_{j} \cdot {Y}_{ij} \cdot cos ( {δ}_{i} - {δ}_{j} - {θ}_{ij} ) & Eq . 1 \\ {Q}_{i} = {Q}_{G , i} - {Q}_{L , i} = {\sum }_{j = 1}^{n} {V}_{i} \cdot {V}_{j} \cdot {Y}_{ij} \cdot sin ( {δ}_{i} - {δ}_{j} - {θ}_{ij} ) & Eq . 2\end{matrix}$$

where n is the number of buses in the network. P_{G, i} is the scheduled active power being generated at bus-i and P_{L, i} is the active power load at bus-i. Likewise for reactive power, Q_{G, i} is the scheduled reactive power being generated at bus-i and Q_{L, i} is the reactive power load at bus-i. Vᵢ is the voltage at bus-i. Vⱼ is the voltage at bus-j. Yᵢⱼ is the i·j admittance element. θᵢⱼ is the angle of i·j admittance element. δᵢ is the voltage angle at bus-i. δⱼ is the voltage angle at bus-j.

To show the relationship of active power, reactive power, voltage angle and voltage magnitude, the linearized equation for the load flow related to these variables can be described as:

$$[ \begin{matrix}Δ P \\ Δ Q\end{matrix} ] = [ J ] [ \begin{matrix}Δ δ \\ Δ V\end{matrix} ] \qquad Eq . 3$$

where ΔP is the linearized active power, ΔQ is the linearized reactive power, Δδ is the linearized voltage angle, ΔV is the linearized voltage magnitude. [J] is Jacobian matrix, which can be expressed as:

$$[ J ] = [ \begin{matrix}{J}_{11} & {J}_{12} \\ {J}_{21} & {J}_{22}\end{matrix} ] = [ \begin{matrix}\frac{\partial P}{\partial δ} & \frac{\partial P}{\partial V} \\ \frac{\partial Q}{\partial δ} & \frac{\partial Q}{\partial V}\end{matrix} ] \qquad Eq . 4$$

Considering that for the slack bus, i.e. the grid tied point, the voltage magnitude V and voltage angle δ are known the linearized equation for the load flow for n buses can be expressed as:

$$[ \begin{matrix}Δ {P}_{2} \\ ⋮ \\ Δ {P}_{n} \\ Δ {Q}_{2} \\ ⋮ \\ Δ {Q}_{n}\end{matrix} ] = [ \begin{matrix}\frac{\partial {P}_{2}}{\partial {δ}_{2}} & … & \frac{\partial {P}_{2}}{\partial {δ}_{n}} & \frac{\partial {P}_{2}}{\partial {V}_{2}} & … & \frac{\partial {P}_{2}}{\partial {V}_{n}} \\ ⋮ & & ⋮ & ⋮ & & ⋮ \\ \frac{\partial {P}_{n}}{\partial {δ}_{2}} & … & \frac{\partial {P}_{n}}{\partial {δ}_{n}} & \frac{\partial {P}_{n}}{\partial {V}_{2}} & … & \frac{\partial {P}_{n}}{\partial {V}_{n}} \\ \frac{\partial {Q}_{2}}{\partial {δ}_{2}} & … & \frac{\partial {Q}_{2}}{\partial {δ}_{n}} & \frac{\partial {Q}_{2}}{\partial {V}_{2}} & … & \frac{\partial {Q}_{2}}{\partial {V}_{n}} \\ ⋮ & & ⋮ & ⋮ & & ⋮ \\ \frac{\partial {Q}_{n}}{\partial {δ}_{2}} & … & \frac{\partial {Q}_{n}}{\partial {δ}_{n}} & \frac{\partial {Q}_{n}}{\partial {V}_{2}} & … & \frac{\partial {Q}_{n}}{\partial {V}_{n}}\end{matrix} ] [ \begin{matrix}Δ {δ}_{2} \\ ⋮ \\ Δ {δ}_{n} \\ Δ {V}_{2} \\ ⋮ \\ Δ {V}_{n}\end{matrix} ] \qquad Eq . 5$$

In power transmission networks with an inductive behavior the so-called “decoupled power flow method” can be used to describe the relation of the active power, reactive power, voltage angle and voltage magnitude. The principle of the method is based on the two main mathematical and physical relations:
Small change in voltage angle δ at a bus effects more or less only the active power P transmission into the grid.
Small change in voltage magnitude V at a bus effects more or less only the reactive power Q transmission into the grid.

These causes will lead to the results concerning the Jacobi matrix [J] as follows:
   |∂P/∂δ|>>|∂Q/∂δ| gives that the elements of the submatrix J₂₁ is approximately zero and
   |∂Q/∂V|>>|∂P/∂V| gives that the elements of the submatrix J₁₂ is approximately zero.

It can be summarized that the active power P is related directly to the voltage angle δ while the reactive power Q is related directly to the voltage magnitude V. As a result, the linearized equation can be described as:

$$[ \begin{matrix}Δ {P}_{2} \\ ⋮ \\ Δ {P}_{n} \\ Δ {Q}_{2} \\ ⋮ \\ Δ {Q}_{n}\end{matrix} ] = [ \begin{matrix}\frac{\partial {P}_{2}}{\partial {δ}_{2}} & … & \frac{\partial {P}_{2}}{\partial {δ}_{n}} & & & \\ ⋮ & & ⋮ & & & \\ \frac{\partial {P}_{n}}{\partial {δ}_{2}} & … & \frac{\partial {P}_{n}}{\partial {δ}_{n}} & & & \\ & & & \frac{\partial {Q}_{2}}{\partial {V}_{2}} & … & \frac{\partial {Q}_{2}}{\partial {V}_{n}} \\ & & & ⋮ & & ⋮ \\ & & & \frac{\partial {Q}_{n}}{\partial {V}_{2}} & … & \frac{\partial {Q}_{n}}{\partial {V}_{n}}\end{matrix} ] [ \begin{matrix}Δ {δ}_{2} \\ ⋮ \\ Δ {δ}_{n} \\ Δ {V}_{2} \\ ⋮ \\ Δ {V}_{n}\end{matrix} ] \qquad Eq . 6$$

This matrix is called as a “P−Q decoupling”. This matrix equation Eq. 6 can be separated into two individual equations as:

$$\begin{matrix}[ \begin{matrix}Δ {P}_{2} \\ ⋮ \\ Δ {P}_{n}\end{matrix} ] = [ \begin{matrix}\frac{\partial {P}_{2}}{\partial {δ}_{2}} & … & \frac{\partial {P}_{2}}{\partial {δ}_{n}} \\ ⋮ & & ⋮ \\ \frac{\partial {P}_{n}}{\partial {δ}_{2}} & … & \frac{\partial {P}_{n}}{\partial {δ}_{n}}\end{matrix} ] [ \begin{matrix}Δ {δ}_{2} \\ ⋮ \\ Δ {δ}_{n}\end{matrix} ] & Eq . 7 \\ [ \begin{matrix}Δ {Q}_{2} \\ ⋮ \\ Δ {Q}_{n}\end{matrix} ] = [ \begin{matrix}\frac{\partial {Q}_{2}}{\partial {V}_{2}} & … & \frac{\partial {Q}_{2}}{\partial {V}_{n}} \\ ⋮ & & ⋮ \\ \frac{\partial {Q}_{n}}{\partial {V}_{2}} & … & \frac{\partial {Q}_{n}}{\partial {V}_{n}}\end{matrix} ] [ \begin{matrix}Δ {V}_{2} \\ ⋮ \\ Δ {V}_{n}\end{matrix} ] & Eq . 8\end{matrix}$$

In the dynamic system behavior the voltage angle δ is related to the frequency of the grid. This means, changes in the voltage angle δ can only be effected by changes in the frequency. From the control point of view, in the transmission networks with an inductive behavior, the active power P is consequently related to the system frequency. The reactive power Q is related to the voltage. This will lead to the basic traditional frequency and voltage droop control of conventional power generating units (grid forming case D), which can be written as:

(f_{ref}−fᵢ)=K_{f,i}·(P_{ref,i}−Pᵢ) Eq. 9

(V_{ref,i}−Vᵢ)=K_{V,i}·(Q_{ref,i}−Qᵢ) 10

In terms of the dynamic system description, in Eq. 9 and Eq. 10, f_{ref} is a given reference frequency, for example 50 Hz or 60 Hz, fᵢ is the actual system frequency in the tied point of the generating unit i. K_{f, i} is frequency droop factor of generating unit i. P_{ref, i} is reference active power the generating unit I shall provide. Pᵢ is the actual active power output of generating unit i. V_{ref, i} is reference voltage the generating unit i shall deliver. Vᵢ is the actual voltage of generating unit i. K_{V,i} is voltage droop factor of generating unit i. Q_{ref, i} is reference reactive power the generating unit i shall provide. Qᵢ is the actual reactive power output of generating unit i.

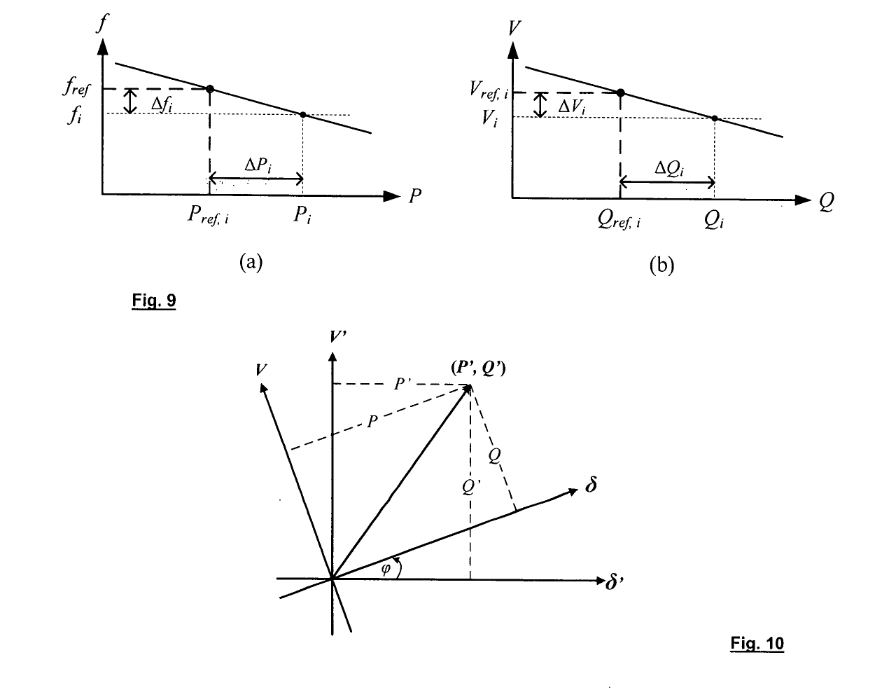

FIG. 9 shows the traditional frequency and voltage droop control relation, which are used in the UCTE Grid Code (UCTE: “Operation Handbook—Introduction”, a.m. and UCTE: “Operational Handbook—Policy 1: Load-Frequency Control”, a.m.). However, as mentioned, the conventional droop functions cannot be used efficiently when applied in MV and LV networks. The reason is that the electrical behavior concerning the grid impedance is related to the resistive nature of the grid. The conventional droop control strategy cannot handle the maintenance of the state variables in the unit control. Therefore, a new droop control is needed to handle the special behavior in MV and LV grids. The following introduced method offers a flexible and general droop control function for power electronic inverters and synchronous generators. The described method is an adaptive control strategy, which takes the grid impedance characteristic into consideration for establishing the droop control function.

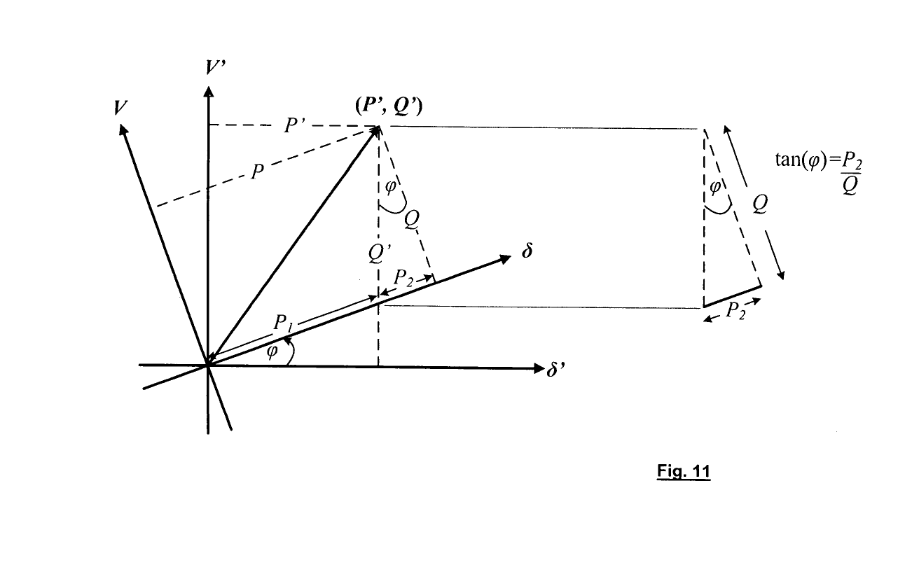

When the relation between the real part R and imaginary part jX of the complex grid impedance Z=R+jX in the tied point of the generating unit changes, this will lead to the change in the relation between frequency f (voltage angle δ) and active power P as well as the relation between the magnitude of the voltage V and reactive power Q. To describe the relation of active and reactive power on frequency and voltage, the rotation transformation of the plane can be used to interpret the relation in a mathematical way. FIG. 10 shows two different reference frames which are the δ′V′-coordinate system and the δV-coordinate system. The δV-coordinate plane rotates by a counterclockwise rotating angle φ in the unrotated δ′V′-coordinate system. The position of P′ and Q′ values in the unrotated δ′V′-coordinate system, in terms of P and Q values in the rotated δV-coordinate system, has to be considered. The P′ and Q′ can be written as functions of rotating angle φ, active power P and reactive power Q in the following general form:

P′=f₁(P,Q,φ) Eq. 11

Q′=f₂(P,Q,φ) Eq. 12

In Eq. 13 and Eq. 14, the active power P and reactive power Q are stated in the δV-rotated coordinate plane while the active power P′ and reactive power Q′ are stated in the δ′V′-unrotated coordinate plane. The relation between the impedance of the grid tied point of each unit is implemented into the droop control for dynamic power and load sharing. The conventional droop control in Eq. 9 and Eq. 10 can be adapted based on the rotation transformation to get a new droop control which is related to the change of the grid impedance. The new frequency and voltage droop control (grid forming case D) of the rotated coordinate system in respect to the unrotated coordinate system for generating unit i can be rewritten in general as:

(f_{ref}−fᵢ)=K_{f,i}·(P′_{ref,i}−P′ᵢ) Eq. 13

(V_{ref}−Vᵢ)=K_{V,i}·(Q′_{ref,i}−Q′ᵢ) Eq. 14

In terms of the dynamic system description, in Eq. 11 and Eq. 12, f_{ref} is the reference frequency of the grid, e.g. 50 Hz or 60 Hz, fᵢ is the actual system frequency in the tied point of the generating unit i. K_{f, i} is frequency droop factor of generating unit 1. V_{ref, i} is reference voltage of generating unit i. Vᵢ is voltage of generating unit i. K_{V, i} is voltage droop factor of generating unit i. P′_{ref, i} and Q′_{ref, i} are the projected reference active and reactive power of generating unit i from rotated plane in respect to the unrotated coordinated system respectively. P′ᵢ and Q′ᵢ are the projected active and reactive power of generating unit i from rotated plane in respect to the unrotated coordinated system respectively.

Regarding the Eq. 13 and Eq. 14, P′ and Q′ functions stated in unrotated coordinated system can be derived in the terms of rotating angle φ, active power P and reactive power Q as following.

To derive P′ in the terms of φ, P and Q, variables P₁ and P₂ are assumed as shown in FIG. 11. The general equation of active power in rotated δV-coordinate system can be expressed as:

P₁=P−P₂ Eq. 15

where P₂=Q tan(φ) as shown in FIG. 11; this leads to

P₁=P−Q tan(φ) Eq. 16

Eq. 16 multiply with cos(φ) gives

$$\begin{matrix}{P}_{1} cos ( ϕ ) = P cos ( ϕ ) - Q tan ( ϕ ) cos ( ϕ ) \\ = P cos ( ϕ ) - Q \\ = P cos ( ϕ ) - Q sin ( ϕ )\end{matrix} \qquad Eq . 17$$

Eq. 17 are substituted by P₁ cos(φ)=P′, this leads to

P′=P cos(φ)−Q sin(φ) Eq. 18

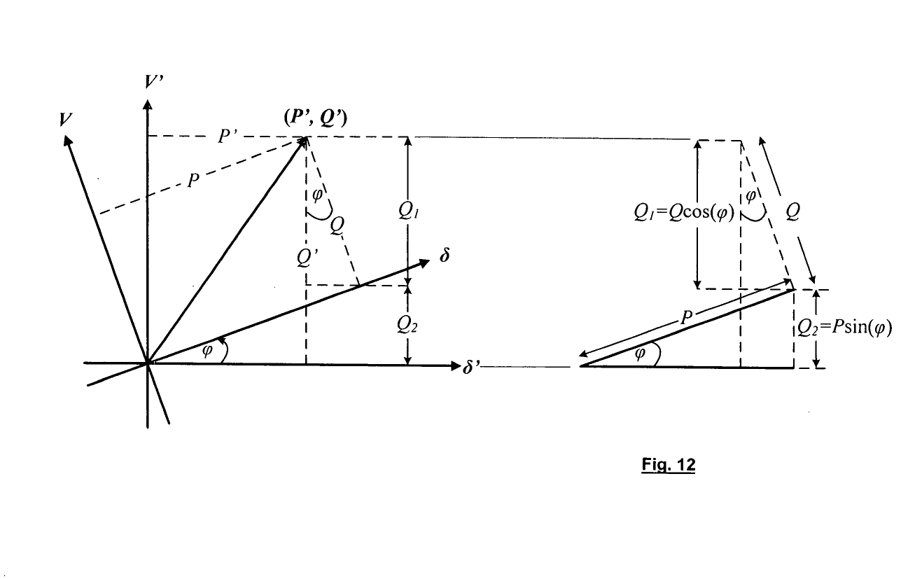

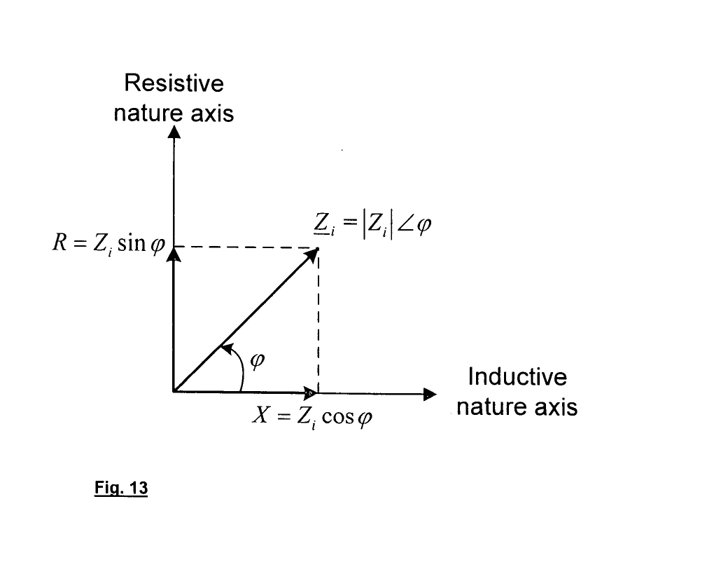

To derive Q′ in the terms of φ, P and Q, variables Q₁ and Q₂ are assumed as shown in FIG. 12. The general equation of reactive power in rotated δV-coordinate system can be expressed as:

Q′=Q₁+Q₂ Eq. 19

where Q₁=Q cos(φ) and Q₂=P sin(φ) as shown in FIG. 12; this leads to

Q′=Q cos(φ)+P sin(φ) Eq. 20

Therefore, new active power P′ and reactive power Q′ can be also modified by rotation transformation matrix based on Eq. 18 and Eq. 20 as follows:

$$[ \begin{matrix}{P}^{′} \\ {Q}^{′}\end{matrix} ] = [ \begin{matrix}cos ϕ & - sin ϕ \\ sin ϕ & cos ϕ\end{matrix} ] [ \begin{matrix}P \\ Q\end{matrix} ] \qquad Eq . 21$$

As the rotating angle φ is moving within the unrotated δ′V′-coordinate system which is referred for the inductive nature axis, the rotated δV-coordinate system is referred for the resistive nature axis. Therefore, the relation of impedance Z related to the rotating angle φ from inductive nature axis to resistive nature axis can be illustrated as in FIG. 13 where Zᵢ=R+jX=|Zᵢ|e^{jφ}. It can be concluded the relation between the rotation angle φ and the resistance R and reactance X as well as follows:

$$\begin{matrix}cos ϕ = \frac{X}{\vert Z \vert} & Eq . 22 \\ sin ϕ = \frac{R}{\vert Z \vert} & Eq . 23\end{matrix}$$

The substitute of the Eq. 22 and Eq. 23 in the rotation matrix (Eq. 21) leads to the general relation:

$$[ \begin{matrix}{P}^{′} \\ {Q}^{′}\end{matrix} ] = [ \begin{matrix}\frac{X}{\vert Z \vert} & - \frac{R}{\vert Z \vert} \\ \frac{R}{\vert Z \vert} & \frac{X}{\vert Z \vert}\end{matrix} ] [ \begin{matrix}P \\ Q\end{matrix} ] \qquad Eq . 24$$

The matrix equation Eq. 24 describes the relation between active and reactive power regarding the impedance of the grid tied point of the individual unit. For both inductive and resistive nature, the resistance R and reactance X related to the gate impedance of the grid tied point of the generating unit are taken into consideration: it leads to the general relation between active and reactive power:

$$\begin{matrix}{P}^{′} = ( \frac{X}{\vert Z \vert} ) P - ( \frac{R}{\vert Z \vert} ) Q & Eq . 25 \\ {Q}^{′} = ( \frac{R}{\vert Z \vert} ) P + ( \frac{X}{\vert Z \vert} ) Q & Eq . 26\end{matrix}$$

The relation between the impedance Zᵢ of the grid tied point of each unit i can be implemented into the droop control for load sharing as described in Eq. 13 and Eq. 14. In combination of Eq. 13, Eq. 14, Eq. 25 and Eq. 26, the new frequency droop control for a generating unit i in grid forming mode D can be described in a mathematical equation as:

$$\begin{matrix}( {f}_{ref} - {f}_{i} ) = {K}_{f , i} \cdot ( {P}_{ref , i}^{′} - {P}_{i}^{′} ) \\ = {K}_{f , i} \cdot ( \begin{matrix}( ( \frac{{X}_{i}}{\vert {Z}_{i} \vert} ) {P}_{ref , i} - ( \frac{{R}_{i}}{\vert {Z}_{i} \vert} ) {Q}_{ref , i} ) - \\ ( ( \frac{{X}_{i}}{\vert {Z}_{i} \vert} ) {P}_{i} - ( \frac{{R}_{i}}{\vert {Z}_{i} \vert} ) {Q}_{i} )\end{matrix} ) \\ = {K}_{f , i} \cdot ( \begin{matrix}( \frac{{X}_{i}}{\vert {Z}_{i} \vert} ) {P}_{ref , i} - ( \frac{{X}_{i}}{\vert {Z}_{i} \vert} ) {P}_{i} - \\ ( \frac{{R}_{i}}{\vert {Z}_{i} \vert} ) {Q}_{ref , i} + ( \frac{{R}_{i}}{\vert {Z}_{i} \vert} ) {Q}_{i}\end{matrix} ) \\ = {K}_{f , i} \cdot ( \frac{{X}_{i}}{\vert {Z}_{i} \vert} ) ( {P}_{ref , i} - {P}_{i} ) - {K}_{f , i} ( \frac{{R}_{i}}{\vert {Z}_{i} \vert} ) ( {Q}_{ref , i} - {Q}_{i} )\end{matrix} \qquad Eq . 27$$

And a new voltage droop control for a generating unit i in grid forming mode D can be described in a mathematical equation as:

$$\begin{matrix}( {V}_{ref} - {V}_{i} ) = {K}_{V , i} \cdot ( {Q}_{ref , i}^{′} - {Q}_{i}^{′} ) \\ = {K}_{V , i} \cdot ( \begin{matrix}( ( \frac{{R}_{i}}{\vert {Z}_{i} \vert} ) {P}_{ref , i} + ( \frac{{X}_{i}}{\vert {Z}_{i} \vert} ) {Q}_{ref , i} ) - \\ ( ( \frac{{R}_{i}}{\vert {Z}_{i} \vert} ) {P}_{i} + ( \frac{{X}_{i}}{\vert {Z}_{i} \vert} ) {Q}_{i} )\end{matrix} ) \\ = {K}_{V , i} \cdot ( \begin{matrix}( \frac{{R}_{i}}{\vert {Z}_{i} \vert} ) {P}_{ref , i} - ( \frac{{R}_{i}}{\vert {Z}_{i} \vert} ) {P}_{i} + \\ ( \frac{{X}_{i}}{\vert {Z}_{i} \vert} ) {Q}_{ref , i} - ( \frac{{X}_{i}}{\vert {Z}_{i} \vert} ) {Q}_{i}\end{matrix} ) \\ = {K}_{V , i} \cdot ( \frac{{R}_{i}}{\vert {Z}_{i} \vert} ) ( {P}_{ref , i} - {P}_{i} ) + {K}_{V , i} ( \frac{{R}_{i}}{\vert {Z}_{i} \vert} ) ( {Q}_{ref , i} - {Q}_{i} )\end{matrix} \qquad Eq . 28$$

In terms of the dynamic system description, in Eq. 27 and Eq. 28, f_{ref} is the reference frequency of the grid, fᵢ is the actual system frequency in the tied point of the generating unit i. K_{f, i} is frequency droop factor of generating unit i. P_{ref, i} is the reference active power the generating unit i shall provide. Pᵢ is the active power output of generating unit i. V_{ref, i} is the reference voltage the generating unit i shall provide. Vᵢ is the actual voltage of generating unit i. K_{V, i} is the voltage droop factor of generating unit i. Q_{ref, i} is the reference reactive power the generating unit i shall provide. Qᵢ is the actual reactive power output of generating unit i. Rᵢ is the resistance in the tied point of the generating unit i. Xᵢ is the reactance in the tied point of the generating unit i. |Zᵢ| is the magnitude of impedance in the tied point of the generating unit i.

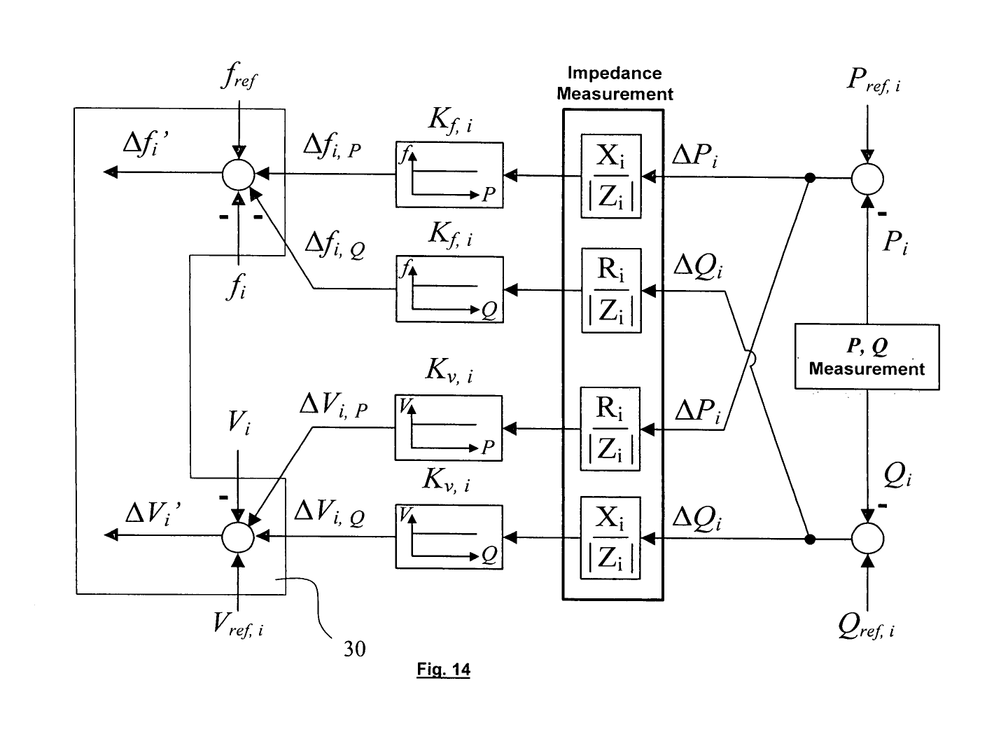

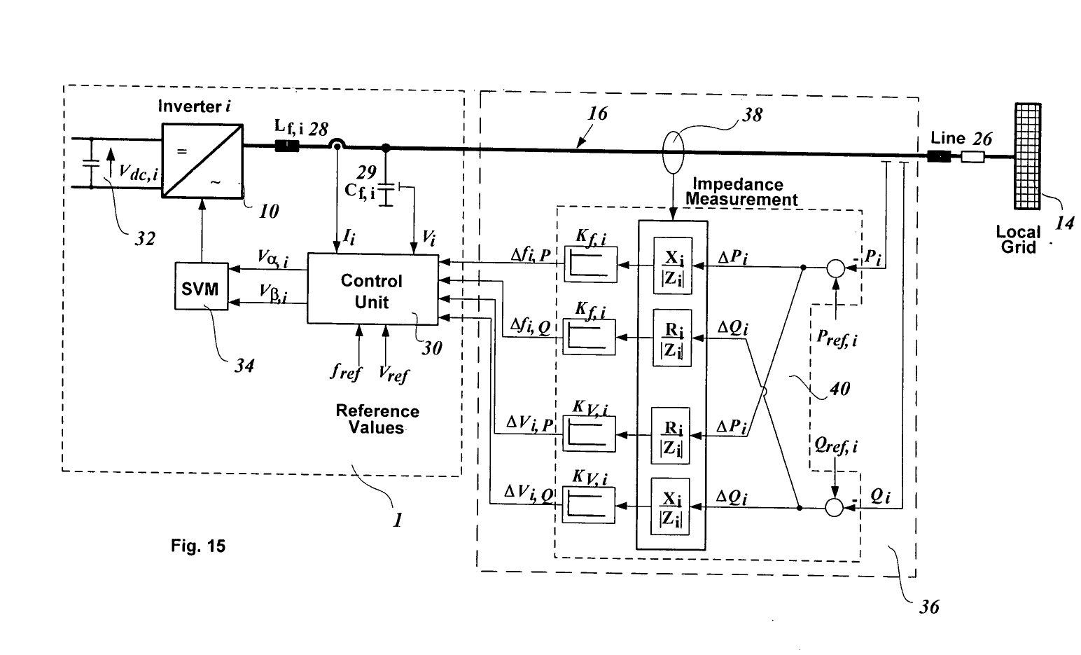

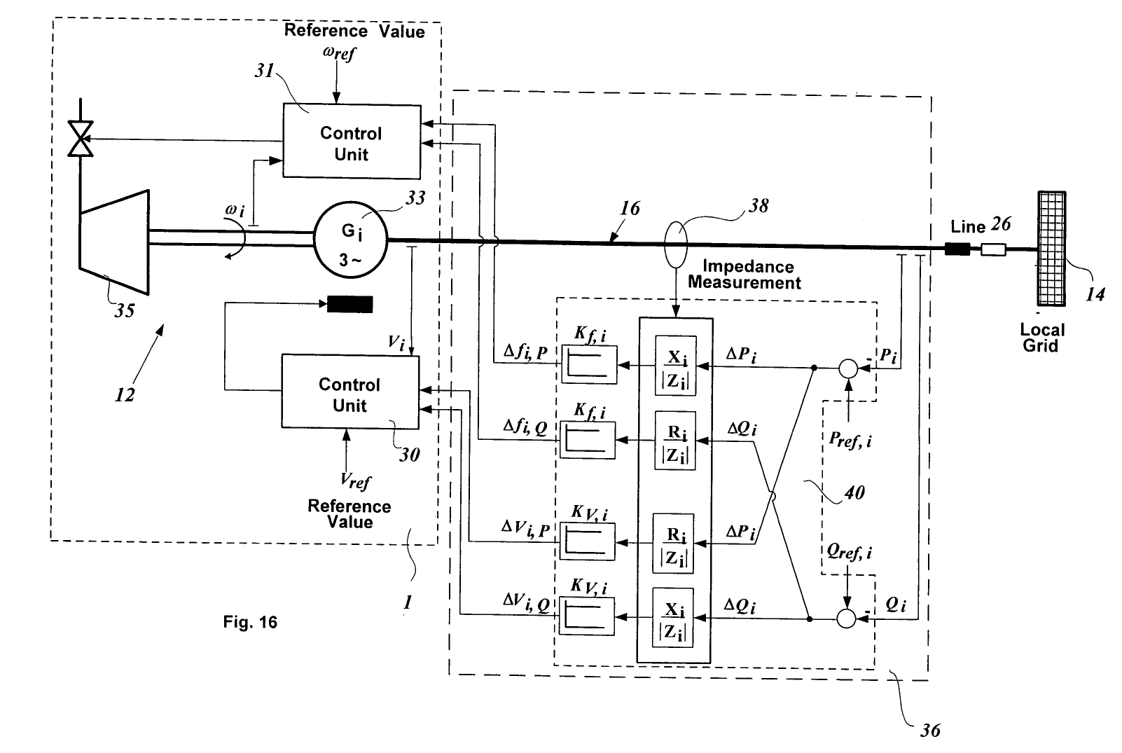

The new droop control based on Eq. 27 and Eq. 28 can be structured as the control structure diagram of the new droop control for grid forming mode D (power electronic inverter and synchronous generator) as shown in FIG. 14 which can be implemented into the control unit 40 in FIG. 6 as shown in FIG. 15 and FIG. 16 respectively.

FIG. 14 schematically shows the method steps of the new frequency droop control and the new voltage droop control each using the relation, i.e. the quotient between the resistance Rᵢ and impedance magnitude |Zᵢ| and the relation, i.e the quotient of the reactance Xᵢ and the impedance magnitude |Zᵢ| for the control of the power generating unit 1. As can be seen the actual active power Pᵢ and the reactive power Qᵢ of the power generating unit 1 that are fed into the grid 14 are determined, for example by direct measurements or by measuring the voltage and current flow at the grid tied point 16 and calculating the active and reactive power from that voltage and current. A reference active power P_{ref,i} and reference reactive power Q_{ref,i} are given/known. These reference values P_{ref,i} and Q_{ref,i} as well as the measured or calculated actual power values Pᵢ and Qᵢ are input values for the new control unit 40 pursuant to FIG. 6.

From these values the active power difference ΔPᵢ between the actual active power Pᵢ delivered from the power generating unit 1 and the given reference active power P_{ref,i}, as well as the reactive power difference ΔQᵢ between the actual reactive power Qᵢ delivered from the power generating unit 1 and a given reference reactive power Q_{ref,i} are calculated. Then a first quotient Rᵢ/|Zᵢ| of the resistance Rᵢ and impedance magnitude |Zᵢ| and a second quotient Xᵢ/|Zᵢ| of the reactance Xᵢ and impedance magnitude |Zᵢ| is used to calculate four products. The calculation of the first and second quotient may be performed at the stage the respective quotient value is needed or previously in a foregoing step, so that the value or values can be used later in proceeding steps. It is then calculated a first frequency product Δf_{i,P} of the active power difference ΔPᵢ, the second quotient Xᵢ/|Zᵢ| and a given frequency droop factor K_{f,i}, a second frequency product Δf_{i,Q} of the reactive power difference ΔQᵢ, the first quotient Rᵢ/|Zᵢ| and the frequency droop factor K_{f,i}, a first voltage product ΔV_{i,P} of the active power difference ΔPᵢ, the first quotient Rᵢ/|Zᵢ| and a given voltage droop factor K_{V,i}, and a second voltage product ΔV_{i,Q} of the reactive power difference ΔQᵢ, the second quotient Xᵢ/|Zᵢ| and the voltage droop factor K_{V,i}. The four products Δf_{i,P}, Δf_{i,Q}, ΔV_{i,P}, ΔV_{i,P} are provided to control unit 30 controlling the frequency fᵢ and the output voltage Vᵢ of the power generating unit 1.

Then the sum of the first frequency product Δf_{i,P} and the negative second frequency product Δf_{i,Q} is calculated to get a frequency correction term Δf_{i,P}−Δf_{i,Q} which is subsequently added to the error f_{ref}−fᵢ of the feedback control of the frequency fᵢ. This can be done within the new control unit 40 or control unit 30 as shown in FIGS. 6 and 14. Furthermore, the sum of the first voltage product ΔV_{i,P} and the second voltage product ΔV_{i,Q} is calculated to get a voltage correction term ΔV_{i,P}+ΔV_{i,Q} which is added to the error V_{ref,i}−Vᵢ of the feedback control of the voltage Vᵢ. This can also be done within the new control unit 40 or control unit 30 as shown in FIGS. 6 and 14. As can be seen in FIG. 6 given reference values for voltage V_{ref} and frequency f_{ref} are provided to control unit 30 to execute the frequency and voltage feedback control. Furthermore the measured voltage V_{G} and current I_{G} are inputted to control unit 30 which derives the actual frequency fᵢ of the power generating unit 1 from one of these parameters. Again turning to FIG. 14 the calculation of the sum from the negative actual frequency fᵢ, the reference frequency f_{ref} and frequency correction term Δf_{i,P}−Δf_{i,Q} forms a new frequency error Δfᵢ′ which is the basis for the feedback control of the frequency. And the calculation of the sum from the negative actual voltage magnitude Vᵢ, the reference voltage V_{ref,i} and voltage correction term ΔV_{i,P}+ΔV_{i,Q} forms a new voltage error ΔVᵢ′ which is the basis for the feedback control of the voltage.

The new droop control in FIG. 14 can be implemented into the control unit 40 in FIG. 6 and, therefore, into the general control strategy of grid forming mode D for the generating unit i (power electronic inverter and synchronous generator) as shown in FIG. 15 and FIG. 16 respectively.

FIG. 16 shows a general control of a power generating unit 1 operating in grid forming mode with inverter 10 droop control according to the invention. The relation between the impedance of the grid tied point of generating unit 1 is implemented into the new droop control unit 40. When the impedance Zᵢ of the grid tied point 16 of generating unit 1 changes, this will lead to the change in the relation between frequency fᵢ, active power Pᵢ, magnitude Vᵢ of the voltage and reactive power Qᵢ of generating unit 1. For example, in the case of inductive nature (transmission network), the value of reactance Xᵢ is much higher than resistance Rᵢ (Xᵢ>>Rᵢ). Therefore, the relation between reactive power Qᵢ and system frequency can be neglected as well as the relation between active power Pᵢ and actual voltage Vᵢ. On the other hand, in the case of resistive nature (distribution network), the value of reactance Xᵢ is much lower than resistance Rᵢ (Xᵢ<<Rᵢ). Therefore, the relation between active power Pᵢ and system frequency fᵢ can be neglected as well as the relation between active power Qᵢ and actual voltage Vᵢ. In summary, this new droop control strategy can be used and implemented into both inductive and resistive nature of power systems. This is due to the impedance Zᵢ of the grid tied point 16 of the generating unit 1 being taken into consideration for the dynamic control and sharing of power.

Likewise, the new droop control according to the invention which may be implemented into the control unit 36, 40 (see FIG. 16) for a synchronous generator 33, is operating the same way as the power electronic inverter 10 explained before. FIG. 16 shows a general control of an ECS 12, i.e. a power generating unit 1 operating in grid forming mode D with a synchronous generator 33 in the control of which the new droop control is implemented. The relation between the impedance of the grid tied point 16 of generating unit 1 is implemented into the new droop control unit 36. Its output values are partly provided to a first conventional control unit 30 controlling the excitation field winding of the synchronous generator 33 and partly to a second conventional control unit 31 controlling valves of ECS 12, for example a turbine 35 directly mechanically connected to the rotor of the synchronous generator 33.

In the case of grid supporting mode E, from the control point of view, in the transmission networks with an inductive behavior, the active power P is related to the system frequency f. The reactive power Q is related to the voltage V. This will lead to the basic traditional active and reactive power droop control of conventional power systems (grid supporting case E), which can be written as:

$$\begin{matrix}( {P}_{ref , i} - {P}_{i} ) = \frac{1}{{K}_{f , i}} \cdot ( {f}_{ref} - {f}_{i } ) & Eq . 29 \\ ( {Q}_{ref , i} - {Q}_{i} ) = \frac{1}{{K}_{V , i}} \cdot ( {V}_{ref , i} - {V}_{i} ) & Eq . 30\end{matrix}$$

In terms of the dynamic system description, in Eq. 29 and Eq. 30, f_{ref} is the reference frequency, fᵢ is the actual system frequency in the tied point of the generating unit i. K_{f, i} is frequency droop factor of generating unit i. P_{ref, i} is reference active power of generating unit i. Pᵢ is active power output of generating unit i. V_{ref, i} is reference voltage of generating unit i. Vᵢ is voltage of generating unit i. K_{V,i} is voltage droop factor of generating unit i. Q_{ref, i} is reference reactive power of generating unit i. Qᵢ is reactive power output of generating unit i. Rotary frequency ω_{ref} as indicated in FIG. 16 equals 2π f_{ref}. Only this reference value ω_{ref} is provided to control unit 31, and only the reference voltage V_{ref} is provided as reference value to control unit 30.

FIG. 17 shows the traditional active and reactive power droop control relation. However, as mentioned, the conventional droop functions cannot be used efficiently when applied in MV and LV networks. The new droop control is also needed for power electronic inverters and synchronous generators in grid supporting mode.

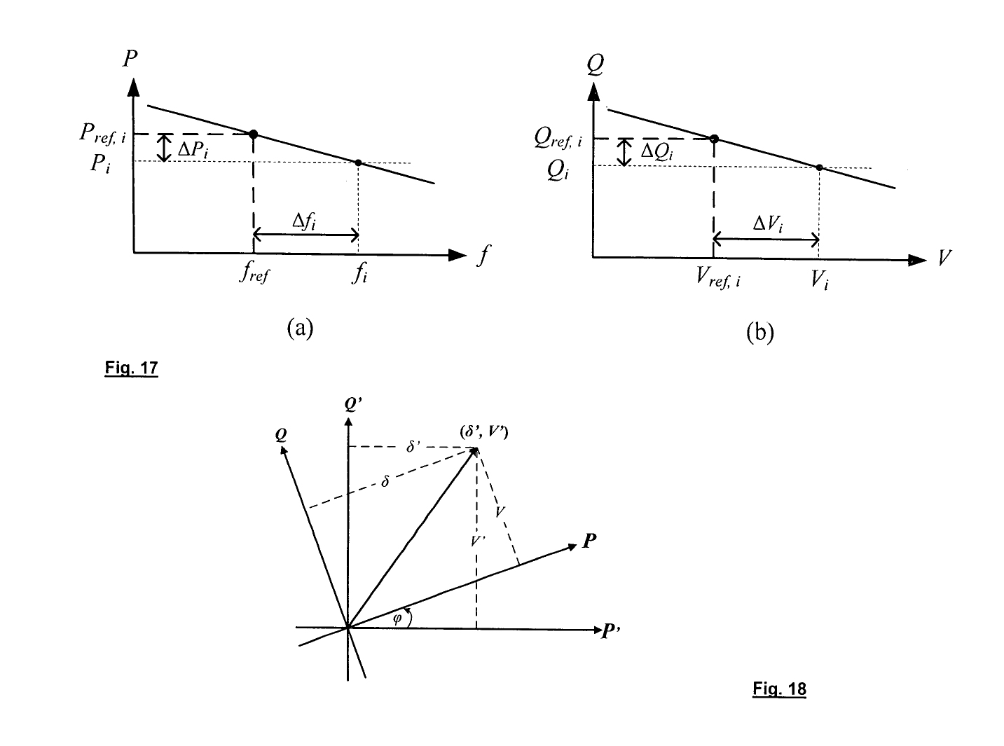

When the relation between the real and imaginary part of the grid impedance changes, this will lead to the change in the relation between frequency fᵢ (voltage angle δ) and active power Pᵢ as well as the relation between the magnitude of the voltage Vᵢ and reactive power Qᵢ. To describe the relation of active and reactive power Pᵢ, Qᵢ on frequency fᵢ and voltage Vᵢ, the rotation transformation of the plane can be used to interpret in a mathematical way, see FIG. 18 which shows two different reference frames, namely the P′Q′-coordinate system and the PQ-coordinate system. The PQ-coordinate plane rotates by a counterclockwise rotating angle φ in the unrotated P′Q′-coordinate system. The position of δ′ and V′ values in the unrotated P′Q′-coordinate system, in terms of δ and V values in the rotated PQ-coordinate system, has to be considered. The δ′ and V′ can be written as functions of rotating angle φ, voltage angle δ and voltage V in the following general form:

δ′=f₁(δ,V,φ) Eq. 31

V′=f₂(δ,V,φ) Eq. 32

In Eq. 31 and Eq. 32, the voltage angle δ and voltage V are stated in the PQ-rotated coordinate plane while the new voltage angle δ′ and the new voltage V′ are stated in the P′Q′-unrotated coordinate plane. The relation between the impedance of the grid tied point of each unit can be implemented into the droop control for dynamic power and load sharing. The conventional droop control of grid supporting mode E in Eq. 29 and Eq. 30 can be adapted based on the rotation transformation to get a new droop control, which is related to the change of the grid impedance. The new active and reactive power droop control (grid supporting case) of the rotated coordinate system in respect to the unrotated coordinate system for generating unit i can be rewritten in general as:

$$\begin{matrix}( {P}_{ref , i} - {P}_{i} ) = \frac{1}{{K}_{f , i}} \cdot ( {f}_{ref}^{′} - {f}_{i }^{′} ) & Eq . 33 \\ ( {Q}_{ref , i} - {Q}_{i} ) = \frac{1}{{K}_{V , i}} \cdot ( {V}_{ref , i}^{′} - {V}_{i}^{′} ) & Eq . 34\end{matrix}$$

In terms of the dynamic system description, in Eq. 33 and Eq. 34, P_{ref, i} is the reference active power of the generating unit i, Pᵢ is the active power output in the tied point of the generating unit i. K_{f, i} is frequency droop factor of generating unit i. Q_{ref, i} is the reference reactive power of generating unit i. Qᵢ is the reactive power output of generating unit i. K_{V, i} is voltage droop factor of generating unit i. f′_{ref} and V′_{ref, i} are the projected reference frequency and voltage of generating unit i from rotated plane in respect to the unrotated coordinated system respectively. f′ᵢ and V′ᵢ are the projected frequency and voltage of generating unit i from rotated plane in respect to the unrotated coordinated system respectively.

Regarding the Eq. 33 and Eq. 34, f′ represented for δ′ and V′, are stated in unrotated coordinated system, can be derived in the terms of rotating angle φ, voltage angle δ and voltage V as follows.

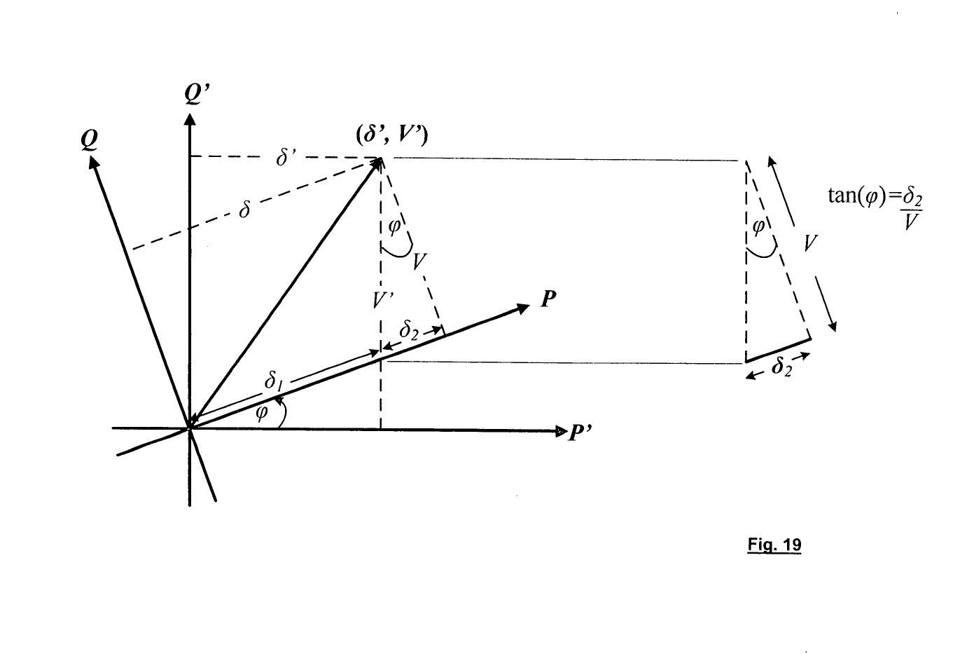

To derive δ′ in the terms of φ, δ and V, variables δ₁ and δ₂ are assumed as shown in FIG. 19. The general equation of voltage angle in rotated PQ-coordinate system can be expressed as:

δ₁=δ−δ₂ Eq. 35

where δ₂=V tan(φ) as shown in FIG. 19, this leads to

δ₁=δ−V tan(φ) Eq. 36

Eq. 36 multiplied with cos(φ) gives

$$\begin{matrix}{δ}_{1} cos ( ϕ ) = δcos ( ϕ ) - V tan ( ϕ ) cos ( ϕ ) \\ = δcos ( ϕ ) - V \\ = δcos ( ϕ ) - V sin ( ϕ )\end{matrix} \qquad Eq . 37$$

Eq. 37 are substituted by δ₁ cos(φ)=δ′, this leads to

δ′=δ cos(φ)−V sin(φ) Eq. 38

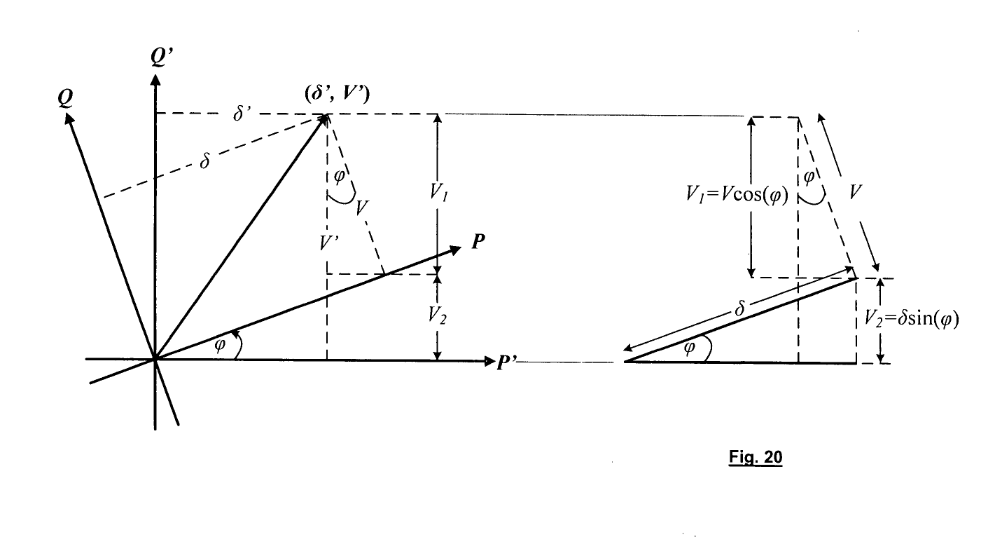

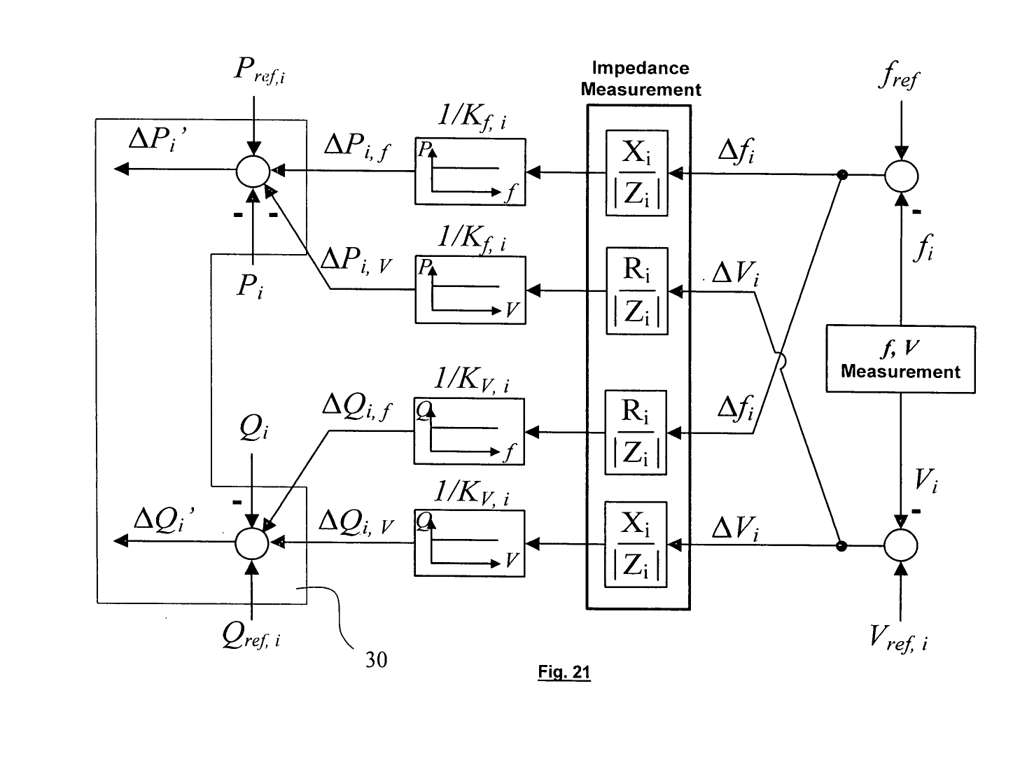

To derive V′ in the terms of φ, δ and V, variables V₁ and V₂ are assumed as shown in FIG. 20. The general equation of reactive power in rotated PQ-coordinate system can be expressed as:

V′=V₁+V₂ Eq. 39

where V₁=V cos(φ) and V₂=δsin(φ) as shown in FIG. 20, this leads to

V′=V cos(φ)+δ sin(φ) Eq. 40

Therefore, new voltage angle δ′ and voltage V′ can be also modified by rotation transformation matrix based on Eq. 38 and Eq. 40 as follows:

$$[ \begin{matrix}{δ}^{′} \\ {V}^{′}\end{matrix} ] = [ \begin{matrix}cos ϕ & - sin ϕ \\ sin ϕ & cos ϕ\end{matrix} ] [ \begin{matrix}δ \\ V\end{matrix} ] \qquad Eq . 41$$

The substitute of the Eq. 22 and Eq. 23 in the rotation matrix (Eq. 41) leads to the general relation:

$$[ \begin{matrix}{δ}^{′} \\ {V}^{′}\end{matrix} ] = [ \begin{matrix}\frac{X}{\vert Z \vert} & - \frac{R}{\vert Z \vert} \\ \frac{R}{\vert Z \vert} & \frac{X}{\vert Z \vert}\end{matrix} ] [ \begin{matrix}δ \\ V\end{matrix} ] \qquad Eq . 42$$

This matrix equation Eq. 42 describes the relation between voltage angle δ and voltage V regarding the impedance Z of the grid tied point of the individual power unit. For both inductive and resistive nature, the resistance R and reactance X related to the gate impedance Z of the grid tied point of the generating unit are taken into consideration: it leads to the general relation between voltage angle δ and voltage V:

$$\begin{matrix}{δ}^{′} = ( \frac{X}{\vert Z \vert} ) δ - ( \frac{R}{\vert Z \vert} ) V & Eq . 43 \\ {V}^{′} = ( \frac{R}{\vert Z \vert} ) δ + ( \frac{X}{\vert Z \vert} ) V & Eq . 44\end{matrix}$$

The relation between the impedance Zᵢ of the grid tied point of each unit i can be implemented into the droop control for load sharing as described in Eq. 33 and Eq. 34. Eq. 42, as mentioned, in the dynamic system behavior, the voltage angle δ is related to the frequency f of the grid. This means, changes in the voltage angle δ can only be effected by changes in the frequency f. Therefore, in combination of Eq. 33, Eq. 34, Eq. 43, Eq. 44, the new active power droop control for a generating unit i in grid supporting mode can be described in a mathematical equation as:

$$\begin{matrix}( {P}_{ref , i} - {P}_{i} ) = \frac{1}{{K}_{f , i}} \cdot ( {f}_{ref}^{′} - {f}_{i}^{′} ) \\ = \frac{1}{{K}_{f , i}} \cdot ( \begin{matrix}( ( \frac{{X}_{i}}{\vert {Z}_{i} \vert} ) {f}_{ref} - ( \frac{{R}_{i}}{\vert {Z}_{i} \vert} ) {V}_{ref , i} ) - \\ ( ( \frac{{X}_{i}}{\vert {Z}_{i} \vert} ) {f}_{i} - ( \frac{{R}_{i}}{\vert {Z}_{i} \vert} ) {V}_{i} )\end{matrix} ) \\ = \frac{1}{{K}_{f , i}} \cdot ( \begin{matrix}( \frac{{X}_{i}}{\vert {Z}_{i} \vert} ) {f}_{ref} - ( \frac{{X}_{i}}{\vert {Z}_{i} \vert} ) {f}_{i} - \\ ( \frac{{R}_{i}}{\vert {Z}_{i} \vert} ) {V}_{ref , i} + ( \frac{{R}_{i}}{\vert {Z}_{i} \vert} ) {V}_{i}\end{matrix} ) \\ = \begin{matrix}\frac{1}{{K}_{f , i}} \cdot ( \frac{{X}_{i}}{\vert {Z}_{i} \vert} ) ( {f}_{ref} - {f}_{i} ) - \\ \frac{1}{{K}_{f , i}} \cdot ( \frac{{R}_{i}}{\vert {Z}_{i} \vert} ) ( {V}_{ref , i} - {V}_{i} )\end{matrix}\end{matrix} \qquad Eq . 45$$

And a new reactive power droop control for a generating unit i in grid supporting mode can be described in a mathematical equation as:

$$\begin{matrix}( {Q}_{ref , i} - {Q}_{i} ) = \frac{1}{{K}_{V , i}} \cdot ( {V}_{ref}^{′} - {V}_{i}^{′} ) \\ = \frac{1}{{K}_{V , i}} \cdot ( \begin{matrix}( ( \frac{{R}_{i}}{\vert {Z}_{i} \vert} ) {f}_{ref} + ( \frac{{X}_{i}}{\vert {Z}_{i} \vert} ) {V}_{ref , i} ) - \\ ( ( \frac{{R}_{i}}{\vert {Z}_{i} \vert} ) {f}_{i} + ( \frac{{X}_{i}}{\vert {Z}_{i} \vert} ) {V}_{i} )\end{matrix} ) \\ = \frac{1}{{K}_{V , i}} \cdot ( \begin{matrix}( \frac{{R}_{i}}{\vert {Z}_{i} \vert} ) {f}_{ref} - ( \frac{{R}_{i}}{\vert {Z}_{i} \vert} ) {f}_{i} + \\ ( \frac{{X}_{i}}{\vert {Z}_{i} \vert} ) {V}_{ref , i} - ( \frac{{X}_{i}}{\vert {Z}_{i} \vert} ) {V}_{i}\end{matrix} ) \\ = \begin{matrix}\frac{1}{{K}_{V , i}} \cdot ( \frac{{R}_{i}}{\vert {Z}_{i} \vert} ) ( {f}_{ref} - {f}_{i} ) + \\ \frac{1}{{K}_{V , i}} \cdot ( \frac{{X}_{i}}{\vert {Z}_{i} \vert} ) ( {V}_{ref , i} - {V}_{i} )\end{matrix}\end{matrix} \qquad Eq . 46$$

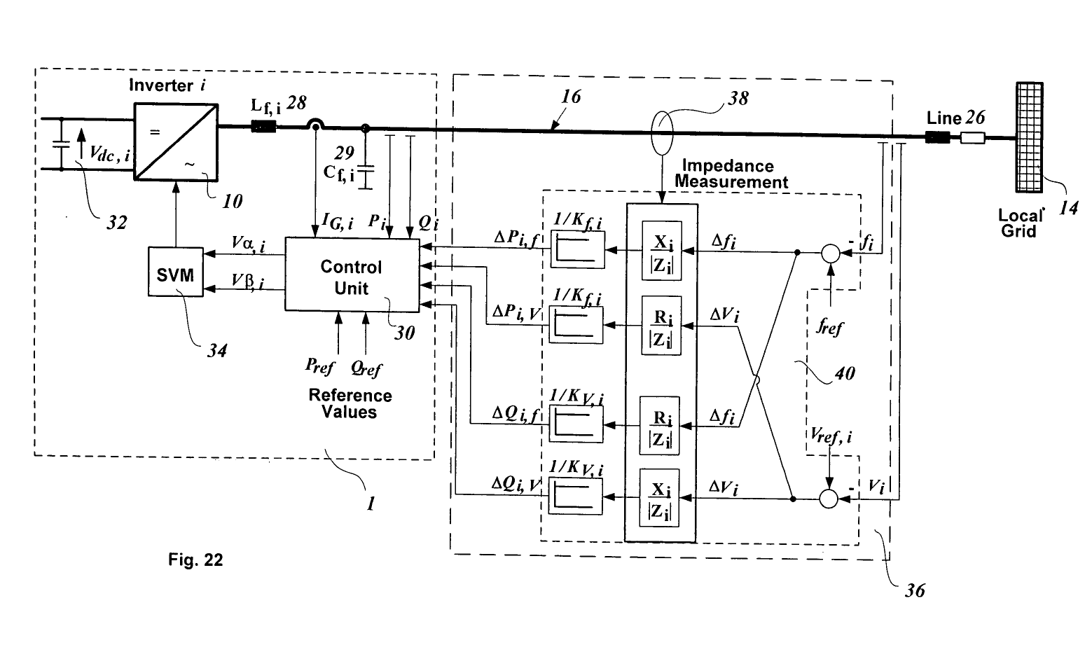

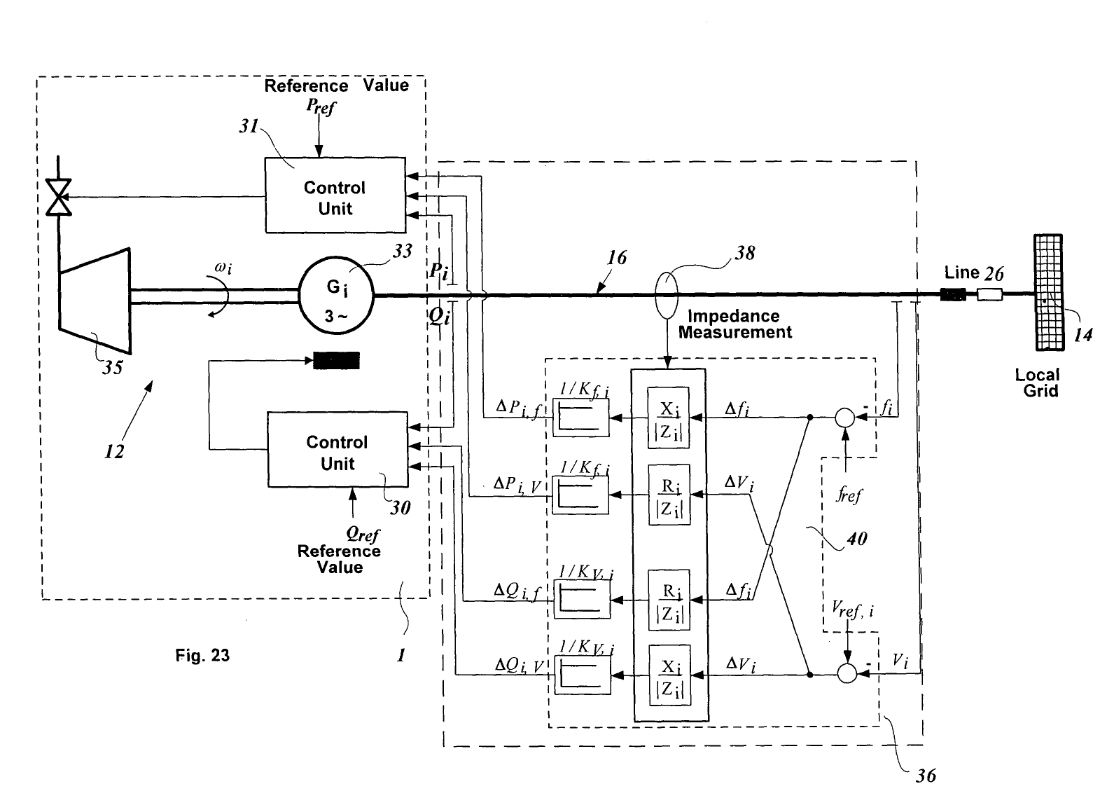

In terms of the dynamic system description, in Eq. 45 and Eq. 46, f_{ref} is the reference frequency, e.g. 50 Hz or 60 Hz, fᵢ is the actual system frequency in the tied point of the generating unit i. K_{f, i} is frequency droop factor of generating unit i. P_{ref, i} is the reference active power the generating unit i shall provide. Pᵢ is the actual active power output of generating unit i. V_{ref, i} is the reference voltage the generating unit i shall provide. Vᵢ is the voltage of generating unit i. K_{V, i} is the voltage droop factor of generating unit i. Q_{ref, i} is the reference reactive power the generating unit i shall provide. Qᵢ is the reactive power output of generating unit i. Rᵢ is the resistance in the tied point of the generating unit i. Xᵢ is the reactance in the tied point of the generating unit i. |Zᵢ| is the magnitude of impedance in the tied point of the generating unit i. The new droop control based on Eq. 45 and Eq. 46 can be structured as the control structure diagram of the new droop control for grid supporting mode as shown in FIG. 21. The new droop control in FIG. 21 can be implemented into the general control strategy of grid supporting mode E for the generating unit i (power electronic inverter and synchronous generator) which can be implemented into the control unit 36 in FIG. 6 as shown in FIG. 22 and FIG. 23 respectively.

FIG. 21 schematically shows the method steps of the new active power droop control and the new reactive power droop control each using the relation/the quotient between the resistance Rᵢ and impedance magnitude |Zᵢ| and the relation/the quotient of the reactance Xᵢ and the impedance magnitude |Zᵢ| for the control of the power generating unit 1. As can be seen the actual system frequency fᵢ of the unit 1 and its actual voltage Vᵢ are determined, for example by direct measurements in case of the voltage and/or, as far as the frequency is concerned, by measuring the voltage or current flow at the grid tied point 16 and calculating the frequency from that voltage or current. A reference frequency f_{ref} and reference voltage V_{ref,i} are given. These reference values f_{ref} and V_{ref,i} as well as the measured or calculated actual frequency and voltage values fᵢ and Vᵢ are input values for the new control unit 36 pursuant to FIG. 6.

From these values the frequency difference Δfᵢ between the actual frequency fᵢ of the power generating unit 1 and the given reference frequency f_{ref}, and the voltage difference ΔVᵢ between the actual voltage Vᵢ at the output terminals of the power generating unit 1 and a given reference voltage V_{ref,I} is calculated. Then a first quotient Rᵢ/|Zᵢ| of the resistance Rᵢ and impedance magnitude |Zᵢ| and a second quotient Xᵢ/|Zᵢ| of the reactance Xᵢ and impedance magnitude |Zᵢ| is used to calculate four products. The calculation of the first and second quotient may be performed at the stage the respective quotient value is needed or previously in an advanced step, so that the value or values can be used later in proceeding steps. It is then calculated a first active power product ΔP_{i,f} of the frequency difference Δfᵢ, the second quotient Xᵢ/|Zᵢ| and a given active power droop factor 1/K_{f,i} that equals the inverted given frequency droop factor K_{f,i}. Furthermore, it is calculated a second active power product ΔP_{i,V} of the voltage difference ΔVᵢ, the first quotient Rᵢ/|Zᵢ| and the active power droop factor (1/K_{f,i}), a first reactive power product ΔQ_{i,f} of the frequency difference Δfᵢ, the first quotient Rᵢ/|Zᵢ| and a given reactive power droop factor 1/K_{V,i} that equals the inverted given voltage droop factor K_{f,i}. Finally, it is calculated a second reactive power product ΔQ_{i,V} of the voltage difference ΔVᵢ, the second quotient Xᵢ/|Zᵢ| and the reactive power droop factor 1/K_{V,i}. The four products ΔP_{i,f}, ΔQ_{i,f}, ΔQ_{i,V} are provided to control unit 30 controlling the active power Pᵢ and reactive power Qᵢ output of the power generating unit 1.

Then the sum of the first active power product ΔP_{i,f} and the negative second active power product ΔP_{i,V} is calculated to get an active power correction term ΔP_{i,f}−ΔP_{i,V} which is subsequently added to the error P_{ref,i}−Pᵢ of the feedback control of the active power Pᵢ. This can be done within the new control unit 40 or control unit 30 as shown in FIGS. 21 and 22. Furthermore, the sum of the first reactive power product ΔQ_{i,f} and the second reactive power product ΔQ_{i,V} is calculated to get a reactive power correction term ΔQ_{i,f}+ΔQ_{i,V} which is added to the error Q_{ref,i}−Qᵢ of the feedback control of the reactive power Qᵢ. This can also be done within the new control unit 40 or control unit 30 as shown in FIGS. 21 and 22. As can be seen in FIG. 6 given reference values for active power P_{ref,i} and reactive power Q_{ref,i} are provided to this control unit 30 to execute the frequency and voltage feedback control. Furthermore the measured actual voltage V_{G} and current I_{G} are inputted to control unit 30 which calculates the actual active and reactive power Pᵢ, Qᵢ of the power generating unit 1 from these parameters.

Again turning to FIG. 21 the calculation of the sum from the negative actual active power Pᵢ, the reference active power P_{ref,i} and the active power correction term ΔP_{i,f}−ΔP_{i,V} forms a new active power error ΔPᵢ′ which is the basis for the feedback control of the active power Pᵢ. And the calculation of the sum from the negative actual reactive power Qᵢ, the reference reactive power Q_{ref,i} and reactive power correction term ΔQ_{i,f}+ΔQ_{i,V} forms a new reactive power error ΔQᵢ′ which is the basis for the feedback control of the reactive power.

FIG. 22 shows a general control of a system operating in grid supporting mode E inverter 10 with new droop control implemented in a new droop control unit 36. The relation between the impedance Zᵢ of the grid tied point 16 of generating unit 1 is considered for the new droop control. Here the active power Pᵢ and the reactive power Qᵢ are measured directly. Their values are input values of the control unit 30. When the impedance Zᵢ of the grid tied point 16 of generating unit 1 changes, this will lead to the change in the relation between frequency fᵢ, active power Pᵢ, magnitude of the voltage Vᵢ and reactive power Qᵢ of generating unit 1. For example, in the case of inductive nature (transmission network), the value of reactance Xᵢ is much higher than resistance Rᵢ (Xᵢ>>Rᵢ). Therefore, the relation between reactive power Qᵢ and system frequency fᵢ can be neglected as well as the relation between active power Pᵢ and actual voltage Vᵢ. On the other hand, in the case of resistive nature (distribution network), the value of reactance Xᵢ is much lower than resistance Rᵢ (Xᵢ<<Rᵢ). Therefore, the relation between active power Pᵢ and system frequency fᵢ can be neglected as well as the relation between active power Qᵢ and actual voltage Vᵢ.

In summary, this new droop control strategy can be used and implemented into both inductive and resistive nature of power systems. This is due to the impedance Zᵢ of the grid tied point 16 of the generating unit 1 being taken into consideration for the dynamic control and sharing/balancing of power.

Likewise, the new droop control, which is implemented into a synchronous generator 33, is operating the same way as the power electronic inverter 10 in FIG. 22. FIG. 23 shows a general control of a power generating unit 1 operating in grid supporting mode E with an ECS 12 comprising a synchronous generator 33 driven by a turbine 35. The power generating unit 1 is controlled by a first control unit 30 controlling the excitation field winding of the synchronous generator 33, a second control unit 31 controlling at least one valve which controls the rotating frequency ωᵢ of the turbine shaft driving the rotor of the synchronous generator 33, and by a third control unit 36 which comprises the new adaptive grid impedance droop control (AGIDC) 40 delivering correction values to the first and the second control unit 30, 31. The relation between the impedance Zᵢ of the grid tied point 16 of generating unit 6 is implemented into the new droop control unit 36, 40.

The first control unit 30 controls the reactive power output of the synchronous generator 33. The measured actual reactive power Qᵢ is an input value as well as the third product ΔQ_{i,f} and the fourth product ΔQ_{i,V}. The second control unit 31 controls the active power output of the synchronous generator 33. The measured actual active power Pᵢ is an input value as well as the first product ΔP_{i,f} and the second product ΔP_{i,V}.

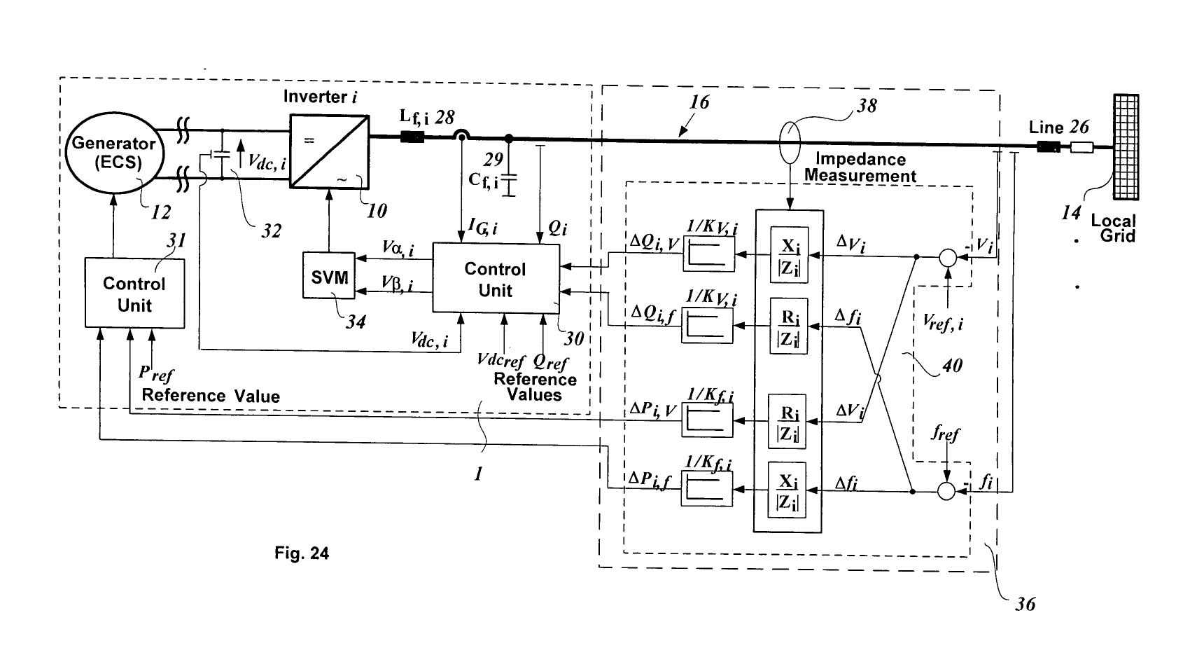

In the case of an inverter in ECS-driven feeding mode A (grid parallel mode C), from the control point of view, in the transmission networks with an inductive behavior, the active power P is related to the system frequency. The reactive power Q is related to the voltage. This will lead to the basic traditional active and reactive power droop control of conventional power systems, which is similar to the grid supporting case E. Therefore, the proposed developed general AGIDC in combination with a gate impedance measurement that is used in grid supporting mode E can be applied into grid parallel mode C as well. The inverter 10 in ECS-driven feeding mode A (grid parallel mode C) requires a reactive power sharing control from the grid side and the active power control from the ECS side. As the proposed developed AGIDC is general and adaptable, the new droop control in FIG. 21 can be implemented into the general control strategy of grid parallel mode C for the generating unit 1 (power electronic inverter) as shown in FIG. 24. For the new droop control of the synchronous generator in grid parallel case C, the active power control is also related to the ECS 12 side.

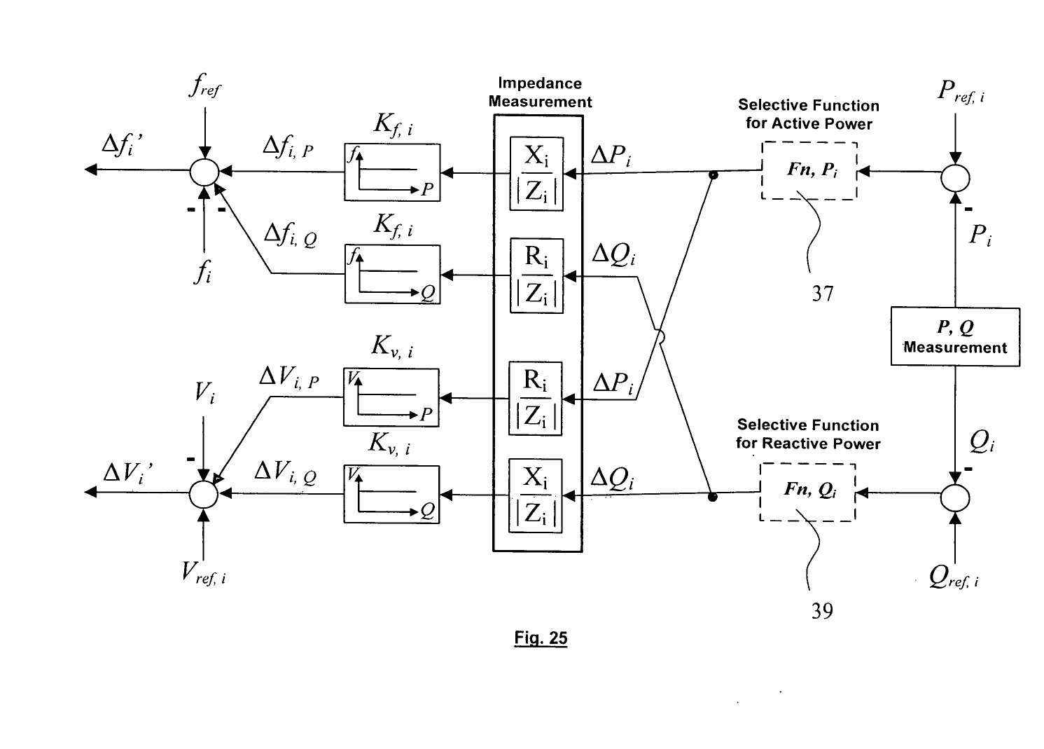

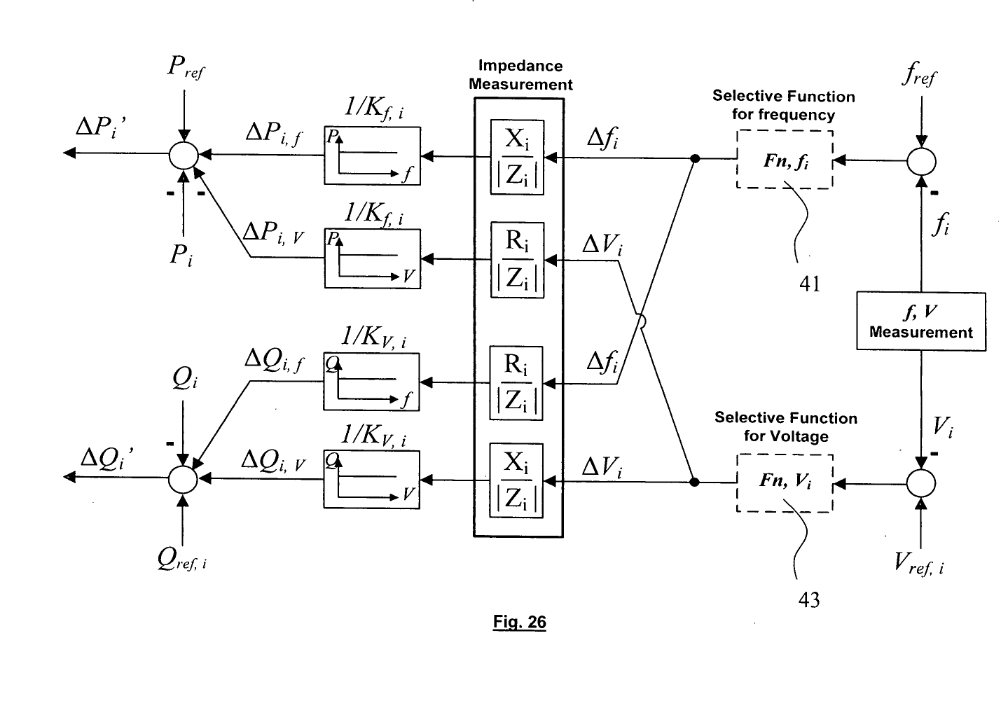

Moreover, for further requirement of future power systems, the proposed AGIDC can be extended with additional selective functions 37, 39 for all feeding modes. Such additional selective function may be non-linear functions, dead band functions or saturation functions like hysteresis or band gap functions which can limit or filter, in particular disregard or differently weighting, certain areas in the complex coordinate plane. FIG. 25 shows new droop control diagram in grid forming mode D with an additional selective function 37 for active power control and an additional selective function 39 for reactive power control for the generating unit 1 (power electronic inverter or synchronous generator). FIG. 26 shows new droop control diagram for grid supporting mode E and grid parallel mode C with an additional selective function 41 for frequency control and an additional selective function 43 for voltage control for the generating unit 1 (power electronic inverter or synchronous generator).

In summary, the proposed innovative control (general AGIDC in combination with gate impedance measurement) is a sharing and power balancing control which can be used and implemented for power generating units in any voltage level, EHV, HV, MV or LV. The proposed innovative control method according to the invention considers the individual impedance Zᵢ of the grid tied point 16 of each generating unit 1. This means that the changes in current Iᵢ and voltage Vᵢ values at measurement grid tied point 16 which results by unknown lines, load variation and disturbances are taken into account for adaptive power sharing and balancing amongst the individual power generating units. The proposed general “AGIDC” for decentralized power supply systems 1 offers the opportunity to bring together the decentralized and centralized power supply systems in compatible coexistence.

1. A method for actively controlling in a feedback control at least one output parameter of a decentralized power generating unit feeding power into a power supply grid having a plurality of such decentralized power generating units, the power generating unit being coupled to the grid at a grid tied point, wherein the actual resistance, reactance and magnitude of the impedance of the power generating unit at the tied point is determined and a first quotient between the resistance and impedance magnitude and a second quotient between the reactance and the impedance magnitude is calculated and used for the feedback control of the at least one output parameter.

2. The method according to claim 1, wherein the controlled output parameter is the frequency of the power generating unit and that the method comprises the steps of:
determining the actual active power and reactive power of the power generating unit that are fed into the grid at the grid tied point,
calculating the active power difference between the actual active power delivered from the power generating unit and a given reference active power,
calculating the reactive power difference between the actual active power delivered from the power generating unit and a given reference active power,
using the second quotient to calculate a first frequency product of the active power difference, the second quotient and a given frequency droop factor,
using the first quotient to calculate a second frequency product of the reactive power difference, the first quotient and the frequency droop factor, and
calculating the sum of the first and the negative second frequency product to get a frequency correction term which is added to the error of the feedback control of the frequency.

3. The method according to claim 1, wherein the controlled output parameter is the voltage of the power generating unit and that the method comprises the steps of:
determining the actual active power and reactive power of the power generating unit that are fed into the grid at the grid tied point,
calculating the active power difference between the actual active power delivered from the power generating unit and a given reference active power,
calculating the reactive power difference between the actual active power delivered from the power generating unit and a given reference active power,
using the first quotient to calculate a first voltage product of the active power difference, the first quotient and a given voltage droop factor,
using the second quotient to calculate a second voltage product of the reactive power difference, the second quotient and the voltage droop factor, and
calculating the sum of the first and the second voltage product to get a voltage correction term which is added to the error of the feedback control of the voltage.

4. The method according to claim 1, wherein the controlled output parameter is the active power of the power generating unit and that the method comprises the steps of:
determining the actual frequency and voltage of the power generating unit at the grid tied point,
calculating the frequency difference between the actual frequency of the power generating unit and a given reference frequency,
calculating the voltage difference between the actual voltage of the power generating unit and a given reference voltage,
using the second quotient to calculate a first active power product of the frequency difference, the second quotient and a given active power droop factor,
using the first quotient to calculate a second active power product of the voltage difference, the first quotient and the active power droop factor, and
calculating the sum of the first and the negative second active power product to get an active power correction term which is added to the error of the feedback control of the active power.

5. The method according to claim 1, wherein the controlled output parameter is the reactive power of the power generating unit and that the method comprises the steps of:
determining the actual frequency and voltage of the power generating unit at the grid tied point,
calculating the frequency difference between the actual frequency of the power generating unit and a given reference frequency,
calculating the voltage difference between the actual voltage of the power generating unit and a given reference voltage,
using the first quotient to calculate a first reactive power product of the frequency difference, the first quotient and a given reactive power droop factor,
using the second quotient to calculate a second reactive power product of the voltage difference, the second quotient and the reactive power droop factor, and
calculating the sum of the first and the second reactive power product to get a reactive power correction term which is added to the error of the feedback control of the reactive power.

6. The method according to claim 4, wherein the active power droop factor equals the inverted value of the frequency droop factor.

7. The method according to claim 5, wherein the reactive power droop factor (???,?) equals the inverted value of the voltage droop factor.

8. The method according to claim 1, wherein
the frequency and the voltage or the active power and the reactive power of each decentralized power generating unit of the grid is controlled using the first quotient and the second quotient is used for the feedback control of the parameters.

9. The method according to claim 2, wherein the active power difference is filtered by a selective function before it is used for calculating a product.

10. The method according to claim 2 wherein the reactive power difference is filtered by a selective function before it is used for calculating a product.

11. The method according to claim 4 wherein the frequency difference is filtered by a selective function before it is used for calculating a product.

12. The method according to claim 4, wherein the voltage difference is filtered by a selective function before it is used for calculating a product.

13. Use of the method according to claim 1, wherein the method is implemented in a power generating unit for extra high voltage, high voltage, medium voltage or low voltage.

14. Use of the method according to claim 1, wherein the method is carried out in a power system with inductive or resistive nature.

15. The use of the method according claim 1, wherein the method is carried out in the control of a synchronous motor or an inverter.

16. The use of the method according to claim 1, wherein the method is carried out in the control of a one phase or three phase inverter.
